(19) United States
(12) Patent Application Publication
(10) Pub. No.: US 2026/0311144 A1
(43) Pub. Date: Oct. 8, 2026

(54) SYSTEM FOR ENHANCING USER ENGAGEMENT IN A DATING APPLICATION THROUGH INCENTIVIZED IN-APP CURRENCY REWARDS

(71) Applicant: PREVUE HOLDINGS, LLC., Crestview, FL (US)

(72) Inventors: Lucanus Grady, Crestview, FL (US); Nicholas Grady, Crestview, FL (US)

(73) Assignee: PREVUE HOLDINGS, LLC., Crestview, FL (US)

(21) Appl. No.: 18/652,794

(22) Filed: May 1, 2024

Related U.S. Application Data
(63) Continuation-in-part of application No. 18/454,749, filed on Aug. 23, 2023, now abandoned.
(60) Provisional application No. 63/400,374, filed on Aug. 23, 2022.

(51) Int. Cl. G06Q 10/42; G06V 10/764; G06V 40/10

(52) U.S. Cl. CPC G06Q 10/42; G06V 10/764; G06V 40/10

(57) ABSTRACT

Some embodiments are directed to a system designed to increase user activity within a dating application. The system comprises a dating application, in-app currency (comprising points, coins, gems, etc.), user accounts with personalization and video upload features, an in-app recorded media module for real-time video content, and a video analysis module utilizing AI/ML algorithms for face detection. Users are incentivized by receiving in-app currency for both video uploads and sharing personal information (such as name, age, gender, ethnicity, job status, etc.), which can be exchanged for rewards, such as virtual badges or stickers for their profiles, temporary access to VIP or high-tier subscriptions, premium photo filters or frames, profile customization options, virtual trophies, entry to exclusive community forums, and the capability to organize virtual events or meetups. This inventive system encourages heightened user engagement and interaction within the dating application, enriching the overall user experience.

### BACKGROUND

The present invention focuses on the field of user engagement in dating applications, with a specific focus on gamification techniques. More specifically, the present disclosure pertains to an application designed to create an engaging and interactive platform for users to share personal In-App recorded media. This media-sharing platform aims to foster user engagement, competition, and enjoyment through gamified elements. The following disclosure also focuses on certain aspects of safety concerns in the field of dating applications.

### SUMMARY

The present disclosure is for a system of enhancing user engagement in a dating application. Dating applications have proven successful in connecting individuals who might not have otherwise crossed paths. They enable users to connect with like-minded individuals in their local areas, transcending traditional social circles. The success of dating applications lies in their ability to match people based on algorithms that align with users' interests.

In the realm of dating applications, there is an opportunity to leverage gamification to enhance user engagement, furthering the change of successful matches with other users. By infusing gamification elements, the application can build trust between users and administrators while making the user experience more entertaining and immersive.

The present disclosure is for a system and method for increasing user activity on a dating application. The application may include users, in-app currency, a user account with at least one feature allowing the user to personalize their account and upload videos to their account, an in-app recorded media feature with an in-app recorded media module for uploading and recording real-time video content directly through the dating application, and a video analysis module that utilizes at least one AI/ML algorithm to detect human faces. Some embodiments may include detecting video background, other objects in the video, and voice recognition.

In some embodiments, the user uploads a video to their account using the in-app recorded media feature, a face is detected in the video by the video analysis module, and the user is rewarded in-app currency for uploading the video. In some embodiments, the user uploads their name, age, gender, ethnicity, and job status the user account, and the user is rewarded in-app currency for uploading the user information.

In some embodiments, the in app-currency is one of points, coins, and gems. In some embodiments, the in-app currency is exchanged for a reward. In some embodiments, the reward is one of a virtual badge or virtual sticker for their profile, access to a VIP or high-tier subscription for a limited amount of time, access to premium photo filters or frames, a profile customization option, a virtual trophy, access to an exclusive community forum, and access to a virtual event or meetup organizer feature. In some embodiments, the in-app recorded media feature allows the user to edit or filter the uploaded video. In some embodiments, in-app recorded media feature prohibits the user from editing or filtering the uploaded video. In some embodiments, users may receive in-app currency for referring other users to the app.

In some embodiments, the in-app recorded media module includes a live video streaming option, allowing users to engage in real-time video interactions with potential matches. Some embodiments may include a user feedback mechanism allowing other users to report suspicious or inappropriate videos. In some embodiments, the video analysis module incorporates metadata analysis to verify a time and location of the video recording. In some embodiments, the video analysis module is used to determine the user's age, race, ethnicity, gender, and background.

In some embodiments, the video analysis module also includes employing machine learning algorithms to continuously improve the accuracy and reliability of attribute determination from the uploaded videos, utilizing data from user interactions and feedback to refine the video analysis process and enhance the matching algorithms, and customizing the matching algorithms to prioritize specific attributes based on user preferences and feedback.

### BRIEF DESCRIPTION OF THE DRAWINGS

FIG. 1 illustrates a block diagram of a distributed computer System that can implement one or more aspects of an embodiment of the present invention.

FIG. 2 illustrates a block diagram of an electronic device that can implement one or more aspects of an embodiment of the invention.

FIG. 3 illustrates the sign up/log in interface where the System enables a user to establish a personal account.

FIG. 4 illustrates an embodiment of an Onboarding interface.

FIG. 5 illustrates an embodiment of a In-App recorded media capture interface.

FIG. 6 illustrates an embodiment of a tutorial interface, depicting how the user may input reactions to a potential connection's profile.

FIG. 7 illustrates an embodiment of a Homepage interface.

FIG. 8 illustrates how the System may present a user's profile for editing information viewable by potential connections.

FIG. 9 illustrates a user's settings page where the System may enable changes to the profile.

FIG. 10 illustrates a user's connections where both parties have enabled the connection.

FIG. 11 illustrates a messaging screen where both parties may communicate.

FIG. 12 illustrates an embodiment of a proximity search between parties.

FIG. 13 illustrates a safety feature where the Administrators may contact users who have been flagged and deliver various stages of warnings.

FIG. 14 illustrates an embodiment of the tiered system.

FIG. 15 illustrates an algorithm executable by the System for providing connections between users.

FIGS. 16A-16B illustrate a workflow depicting navigation of the application.

FIGS. 17A-17M depict source code that can implement one or more aspects of an embodiment of the present invention.

While the invention is described with reference to the above drawings, the drawings are intended to be illustrative, and the invention contemplates other embodiments within the spirit of the invention.

### DETAILED DESCRIPTION

Throughout the specification, wherever practicable, like structures will be identified with reference numbers. In some figures, components, such as additional electrical connections or fasteners have been omitted for clarity in the drawings. Unless expressly stated otherwise, the term “or” means “either or both” such that “A or B” includes A alone, B alone, and both A and B together.

Although the present device and System has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications a fall within the spirit and scope of the invention.

### I. System and Application Overview

The present disclosure relates to an application intended for use on a personal device for users interested in dating other users in their proximate area. The personal device may be the user's cell phone, however any personal device with access to the application may be used.

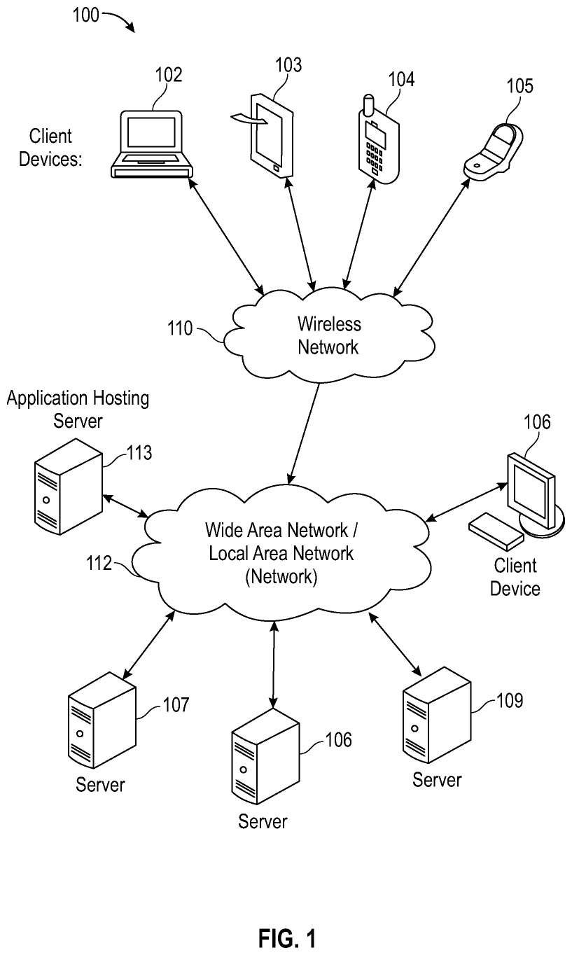

FIG. 1 illustrates components of one embodiment of an environment in which the invention may be practiced. Not all of the components may be required to practice the invention, and variations in the arrangement and type of the components may be made without departing from the spirit or scope of the invention. As shown, the System 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

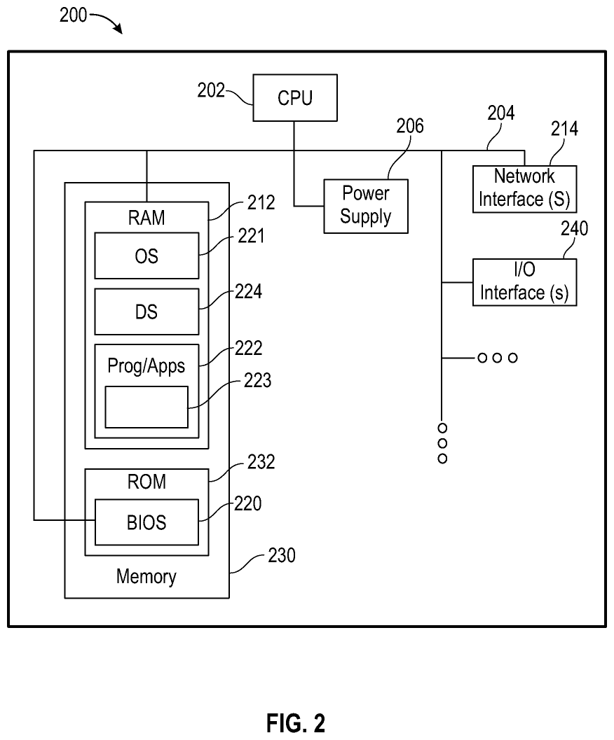

FIG. 2 illustrates a block diagram of an electronic device 200 that can implement one or more aspects of an apparatus, System and method for validating and correcting user information (the “Engine”) according to one embodiment of the invention. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating System 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and Systems according to embodiments of the invention. The elements may exist on a single computer or be distributed among multiple computers, servers, devices or entities.

The power supply 206 contains one or more power components, and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or System 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating System such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, System and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example Systems and methods for the apparatus, System and method embodying the Engine. Content may include, for example, text, images, audio, video, and the like.

In example aspects of the apparatus, System and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, System and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, System and method implementing the Engine, may run a variety of operating Systems, including personal computer operating Systems such as Windows, iOS or Linux, and mobile operating Systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, System and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, System and method implementing the Engine, may couple devices with a network. A wireless network may employ stand-alone ad-hoc networks, mesh networks, Wireless LAN (WLAN) networks, cellular networks, and the like.

A wireless network may further include an autonomous System of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular Systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, System and method implementing the Engine, generally refers to a distributed computer System that comprises a collection of autonomous computers linked by a network or networks, together with the software, Systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, Systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the System may receive, process, generate and/or store time series data. The System may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

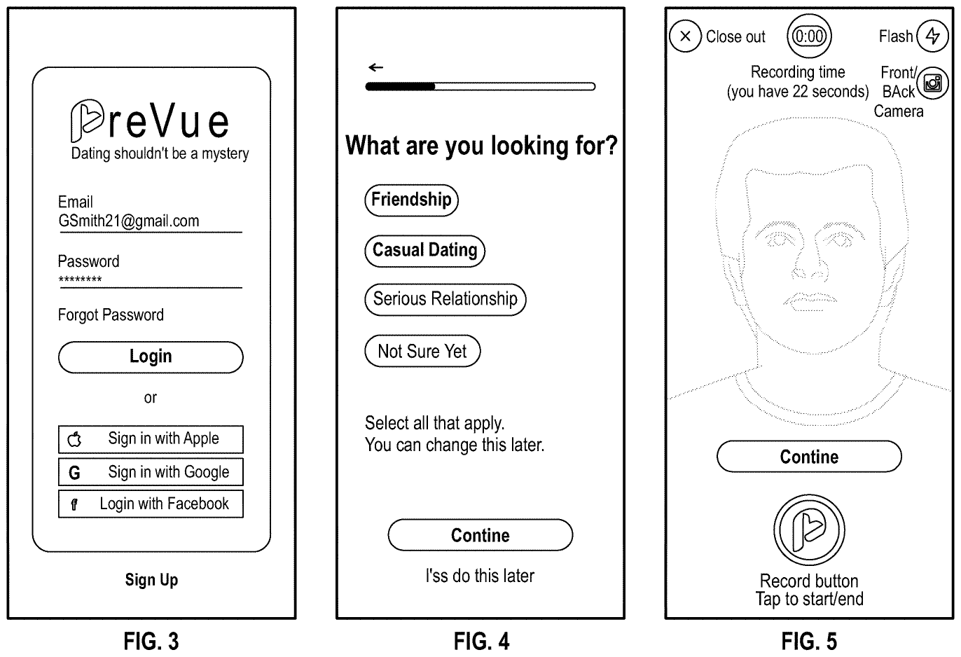

The System may comprise a sign-up module, as shown in FIG. 3. Upon download, the System may direct the user to a sign-up interface. The sign-up interface may prompt the user for personal identifying information in the primary textbox, such as an email address. However, various personal information identifying methods may be utilized, such as but not limited to information extraction and/or sharing via third-party platforms, for example, Apple, Google, or Facebook. As a non-limiting example, the sign-up module may be in informatic communication with such third-party platforms such that log-in credentials associated with such third-party platforms may be utilized for sign-up purposes within the System. This information may function as a username. A keyboard may appear when the user initiates contact with the textbox requesting the user's personal identifying information. A secondary textbox may be present on the screen requesting the user create a password. The password may have a minimum threshold of requirements for safety purposes. This minimum threshold may include a combination of at least 1 upper case letter, 1 lower case letter, 1 number, and at least 8 characters. However, other combinations of characters providing a greater minimum threshold may be required to improve upon the safety of the overall users' account. The password textbox may display the characters typed as non-letter symbols to ensure safety of the user's account accessing information. A tertiary textbox may appear prompting the user to re-enter the password entered in the secondary textbox to confirm the user's apprehension of their password. Upon completion, the System may generate the user's personal account upon actuation of the sign-up icon (for example, wherein the sign-up icon is a selectable digital button). The System may transport the user to the home page interface upon signing up. The System may present a welcome interface upon successful completion.

In the event the System already has an account for the user, the System may recognize the inputted username and password combination. The System may launch the application upon initiation with the Login icon.

The System may generate an Onboarding module after and/or during presentation of the Sign-Up module. The Onboarding module may only be generated when a new account is being created. However, the Onboarding module may be generated and/or displayed at any given interval during execution of the System on a user's device. The System may prompt the user for the user's first name. The System may generate a keyboard when contact has been initiated with the text fields. The System may request a user's first name. In an embodiment, the textbox will require one letter and will auto-capitalize the first letter provided. Upon completion, the System may recognize initiation of the <CONTINUE> icon.

The sequencing of the Onboarding module may follow the present disclosure or may follow a different order. The System may present a tracker on the interface to indicate the user's progress in completing the profile. The tracker may begin at the left end of the interface and as progress is recorded, the tracker may fill with a color. The color may progress to the right side of the interface upon each stage of the onboarding process until completed. Once completed, the color bar may extend from the left side of the interface to the right side of the interface.

The System may generate a birthday input interface. Upon initiation with the text field, a keyboard may be generated where the user may type their birthday in the following format: month, day, year. For single digit months or days, the user may need to enter a “0.” The System may generate the next interface upon initiation with the <CONTINUE> icon. The <CONTINUE> icon may not be accessible until the System has received a complete birthday. In a further embodiment, the application will calculate the user's age. Users above age 18 may be directed to the succeeding interface. Users below 18 may receive a pop up visual with the following verbiage: “To join the community, you need to be 18 years of age or older. If you are not yet 18, we look forward to welcoming you when you're old enough.” However, any variation with similar meaning may be presented. Further, the age limit may be adjustable by a System administrator. The System may then terminate the Onboarding process. The tracker may be adjusted to indicate the user's progress in completing the profile.

The System may generate a Gender Identity input interface. The System may present the following options for gender identity: <Man>, <Woman>, <Non-Binary>, <Prefer Not to Say>, <Other (enter your identity)>. Selection of the option may be shown by the icon changing from one color to another color upon engagement. The System may display the user's selection on the user's profile. The System may present the option <Prefer Not to Say> where the System may not present the user's selection. The System may manifest the <CONTINUE> icon as inaccessible until the user has entered their gender identity. Engaging with the <Man>, <Woman>, <Non-Binary>, and <Prefer Not to Say> options may generate the “Looking For” interface. Engaging with <Other> may generate a text field and keyboard prompting the user to input a gender identity not provided. For example, the user may identify as “Genderqueer.” The user may manually type “Genderqueer” in the text field provided for display profile interface. The System may show completion of the gender identity selection when the selected icon changes from one color to another, indicating the option has been selected. The text field may be required following selection of <Other>. The System may require three characters inputted. Upon completion, the system may recognize engagement with the <CONTINUE> icon provided. The System may allow modifications to the “gender identity” selected throughout the life of the profile. The tracker may be adjusted to indicate the user's progress in completing the profile.

The System may generate a “Looking For” input interface, as shown in FIG. 4. The System may present various options for the type of connection the user is seeking. The following options may be presented: <Friendship>, <Casual Dating>, <Serious Relationship>, <Not Sure Yet>. The System may allow for the selection of more than one option. The System may recognize the selection of an option and the option may change from one color to another to signify selection. Upon completion, the System may recognize engagement with the <CONTINUE> icon provided. The option to put off the selection process and select <I'LL DO THIS LATER> may proceed the user to the next interface. The tracker may be adjusted to indicate the user's progress in completing the profile.

The System may generate a “Show Me” input interface. This interface may give the user the option to filter their matches by gender identity. The System may present the user with the following options: Men, Women, Everyone!. The System may recognize selection of an option. The selection may change from one color to another upon selection. The System may present an option to select a preferred age range. The preferred age range provides the user with a sliding scale. The sliding scale may generate and display a scale from 18-99. The scale may be a bar with a color line over the selected portion. The selected portion may have one circle on either end to indicate the bounds of the selected age range on either end. The user may slide the color bar to indicate their selected age range. However, any visual may be used to allow the user to indicate their preferred age range. The System may recognize engagement with the <CONTINUE> icon upon completion. The System may not recognize the <CONTINUE> icon until a selection has been made for both gender and age range. The user may change both preferences throughout their period of usage with the application. The tracker may be adjusted to indicate the user's progress in completing the profile.

The System may generate an occupation input interface. This interface may provide the user with a text field. The System may recognize initiation with the text field and a keyboard may be generated. The keyboard may auto capitalize the first character. The System may request the user's occupation. The occupation inputted may be displayed on the user's profile to potential connections. The System may require at least three characters in the text field or recognize the selection of <I'LL DO THIS LATER> to proceed to the next interface. The <I'LL DO THIS LATER> option may transport the user to the next interface without providing an occupation. The tracker may be adjusted to indicate the user's progress in completing the profile.

The System may generate the photos input interface. This interface may present the user with the option to select zero, one, two, or three photos for upload. The photos may be presented to the user's connections. The interface may display three blank boxes with an <UPLOAD> icon below them. The System may recognize initiation with the <UPLOAD> icon and the System may generate a prompt requesting access to the user's photos (for example, as stored on the user's device). The System may recognize selection of photos from the personal device's camera roll. A blank box may remain blank if no photo has been selected to fill the respective box. In an embodiment, the personal device may allow the application access to the camera of the user's device. A photo may be taken utilizing the personal device's camera and uploaded directly onto the application. The application may generate a request to access to the camera or gallery. The user may select a photo displayed to prompt <PHOTO OPTIONS> where the user may replace one photo selected with another photo from the gallery of the user's respective phone. The System may recognize removal of the photo selected to no longer showcase the photo on their profile. The System may not recognize the <CONTINUE> icon until the upload is completed. The System may recognize <I'LL DO THIS LATER> to move on to the next module without completing this module or to complete this module at a later time. The tracker may be adjusted to indicate the user's progress in completing the profile.

The System may generate the “Bio” input interface. This interface may provide the user with the option to “Tell us more about yourself” for potential connections. The System may provide a text field indicating “Tell us more about yourself.” A keyboard may be generated following initiation with the text field. The System may provide for 450 characters and a minimum of 1 character in the text field. Below the text field, the interface may provide a fraction of how many characters have been utilized out of the 450 characters available. However, the System may permit any suitable number of characters. The System may not recognize the <CONTINUE> icon until input is completed. The System may recognize <I'LL DO THIS LATER> to move on to the next module without completing this module or to complete this module at a later time. The tracker may be adjusted to indicate the user's progress in completing the profile.

The System may generate a location input interface. This interface may provide the user with a text field where the System may recognize a geographical input. The System may request geographical access through a global positioning system. Location access may auto populate a city and state into the text field. The System may receive a refusal for location access. Refusal of location access may generate a keyboard where the user's geographical data may be inputted. The System may recognize a Zip Code in the text field. The text field may allow a maximum of five digits. The System may not recognize the <CONTINUE> icon until input is completed. The System may recognize <I'LL DO THIS LATER> to proceed to the next module without completing the location input interface or to complete this module at a later time. The user may be given the option to modify this entry throughout their period of usage with the application. The tracker may be adjusted to indicate the user's progress in completing the profile.

The System may generate a proximity input interface. The interface may show a sliding scale with the option to indicate the user's preferred radius in the search for potential connections. The scale may include a grey bar with a color overlay. The color overlay may indicate the user's preferred radius for the search for potential connections. The System may provide the option to choose from a range of 0.5-100 miles. The System may provide a default of 5 miles, however any default may be set. The user may be given a plurality of features. The plurality of features may include a Proximity Extender feature. The Proximity Extender feature may allow the System to recognize an unlimited radius in the search for potential connections. The System may not recognize the <CONTINUE> icon until input is complete. The user may modify this option throughout their period of usage with the application. The tracker may be adjusted to indicate the user's progress in completing the profile.

The Onboarding module may include an In-App recorded media interface. The interface may provide the user with a definition and instructions pertaining to the In-App recorded media. Such an interface may provide a hyperlink, wherein the hyperlink may direct the user to a page with a plurality of tutorials.

The plurality of tutorials may provide basic suggestions on how to record the In-App recorded media. The basic suggestions may be in the form of a video. The videos may be hosted on and/or retrieved from a third-party video platform, such as YouTube. The interface may provide one or more video thumbnails, wherein each of the one or more video thumbnails is selectable. For example, selection of one of the one or more video thumbnails may access one or more of the plurality of tutorials. The tutorials may be generated and displayed on the user's device. For example, videos provided may be “Example [In-App recorded media],” “Topics to get started,” “What not to share,” and “Video lighting and set up,” however a multitude of videos providing suggestions may be used. The user may select a <BACK> icon on this screen to return to the In-App recorded media interface. The user may select a <RECORD YOUR [IN-APP RECORDED MEDIA]> icon to be returned to the In-App recorded media interface.

The System may recognize initiation with the <CONTINUE> icon on the In-App recorded media interface to generate the In-App recorded media recording interface. The recording interface may recognize initiation with <CONTINUE> where the System may request access to the camera/microphone of the user's personal device. The System may recognize permission of access. The System may permit the user the option to record their first In-App recorded media. The camera may default to a native front-facing camera. The interface may include icons, where the icons may include but are not limited to “Recording Time,” “Flash,” “Front/Back Camera,” and “Close out.” The recording time icon may display to the user a media duration for the recording. The media duration for the recording may be displayed in seconds. The “Recording Time” icon may display to the user the time length of their recording. The “Flash” icon may allow or disallow the camera flash on the personal device. The “Front/Back Camera” icon may allow the user to toggle between the personal device's front camera and back camera. The “Close out” icon may return the user to the Application Introduction screen.

In an embodiment, the timer for the recording begins at 0 and ends upon the media duration. The recording may be a media duration optimized to a user's attention span. The media duration may be 22 seconds. However, the In-App recorded media may be a duration equal to or less than the media duration. In a further embodiment, the In-App recorded media may be bound by both the media duration (i.e., the maximum duration) and a minimum duration. The System may not recognize an uploaded video. The System may not be configured to receive video via traditional file upload. For example, the System may reject or may otherwise be incapable of receiving a pre-recorded video file. The System may only allow creation of the In-App recorded media in the application. The In-App recorded media may include an audio and/or visual components. Creating the In-App recorded media on the application may enforce safety features of the app, aimed at preventing any modifications made to the user's personal attributes that inconsistently represent the user's profile in relation to the user in person.

In one embodiment, the In-App recorded media is not modified nor compressed during the recording and or storing process. However, in alternate embodiments, the System may be configured to compress and/or modify the In-App recorded media. The In-App recorded media may be uploaded to buckets of any suitable computing platform. For example, the In-App recorded media may be uploaded to S3 buckets in AWS via the AWS software development kit. Further, the In-App recorded media may be uploaded with preassigned URLs received from a request to the backend. In one embodiment, the In-App recorded media may be recorded, stored, and/or modified to a particular aspect ratio and/or size. Accordingly, said aspect ratio and/or size may be adapted such that the In-App recorded media is sized for presentation on a user's profile. The In-App recorded media may be recorded via native video capture and uploaded via multipart upload with secure encrypted transfer to a S3 bucket. In an embodiment, presentation of the In-App recorded media may require a preassigned URL request and download, and may be viewed over the native media player of the platform. As a non-limiting example, the In-App recorded media may be a MP4 file type. However, the In-App recorded media may be any suitable file type. During recordation of the In-App recorded media, said In-App recorded media may be held in “local” storage until it is uploaded at the end of onboarding. The “local” storage may be discarded at the end of the onboarding phase.

The System may not recognize uploaded videos. This may function as a safety feature. Users may be required to record their In-App recorded media to be viewable by other users directly on the Application (for example, the onboarding module). The Application may prevent or mitigate the alteration of a user's represented media by requiring the In-App recorded media to be created using the Application. Therefore, users may be ensured that the user represented in the In-App recorded media and the user they are communicating with, and may eventually meet, are the same person. Further, video media alterations may require more knowledge and skill than photo media alterations, making it less likely the video media will be altered.

Referring to FIG. 5, the System may recognize a primary initiation with the “Record” icon to generate the recording of the user's In-App recorded media. The System may recognize a secondary initiation (for example, removal of a user's finger from the user device's touch screen) with the “Record” icon to end the video before the media duration has expired. The application may cease recording automatically when the media duration has expired. For example, the media duration may be selected as a function of experimental data determined via focus groups. Further, the media duration may be a temporal period determined to increase a user's attention to a particular connection interface by a desired percent threshold.

The media duration may be evaluated in view of experimental data. The media duration may be scientifically aimed at targeting a user's attention span as to maximize the user's engagement with potential connections. In utilizing the application, users may be presented with various profiles, therefore efficiency becomes preferred. By limiting a user's engagement with potential connections, users may still encounter various potential connections, while still being efficient. The video format may increase the efficiency in this process by allowing users a preview of what they are like in real life, more than a profile merely with identifying information. The media duration may be modified internally by Administration; however, such changes may be seen on all profiles and during all users' onboarding.

The video may begin playing recursively once recordation has ceased. The System may generate an alternate interface where the user may be given the option to select a thumbnail. The thumbnail may be selectable from a frame of their In-App recorded media. The system may also give users multiple options for a thumbnail, generated by one or more AI/ML algorithms. These options may be generated based on the frames recognized to have no blur, a face in the center of the screen, etc. The System may recognize the selection of a frame ultimately cropping the photo. The crop may default to one third of the recordation. However, the crop may default to any fraction that may display the user's face. This may complete the user's profile. However, additional modules requesting supplementary personal data may be implemented. In an embodiment, the System may allow download of the In-App recorded media onto the user's personal device.

The System may generate a “How to Navigate” interface. The System may provide guidelines to the user of how to utilize the application. Upon display of a potential connection's profile, the “How to Navigate” screen may display an overlay on a potential connection's profile. For example, the overlay may display: the time remaining, a “flag content” icon, an up arrow, a down arrow, an x icon and a heart icon.

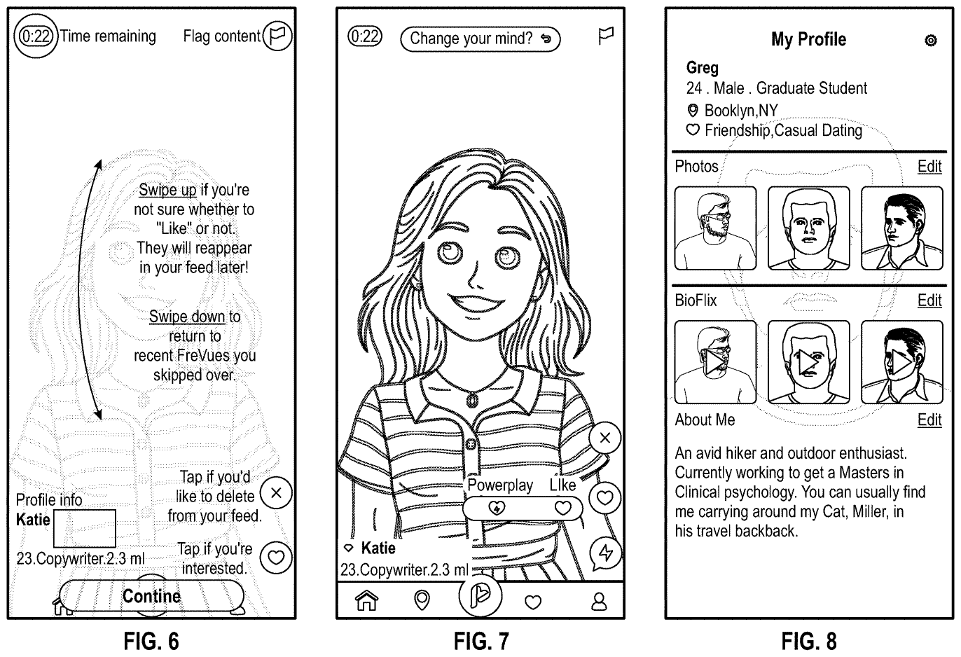

Referring to FIG. 6, the application may assign meaning to each feature in the overlay. The “flag content” feature may indicate the user perceives the potential connection's profile inappropriate or offensive. The time remaining feature may display duration remaining of the potential connection's recordation. The up arrow may indicate the user's option to swipe up on the recordation to mark the user is unsure. The unsure feature may re-circulate the potential connection's profile to the user at a later time. The down arrow may indicate the user's option to swipe down on the In-App recorded media to return to a previously skipped over potential connection (for example, such a skipped over potential connection may be a second user who was marked as deleted from a first user's feed or someone marked unsure). The x icon may indicate the user's option to remove the potential connection from their feed. The heart icon may indicate the user's option to indicate interest with the potential connection. The System may recognize the <CONTINUE> icon to remove the overlay and begin indicating interest with potential connections.

Referring to FIG. 7, the System may generate a homepage interface. This interface may display the potential connections as selected by a connection algorithm. The homepage may display a plurality of features. For example, the homepage may showcase a potential connection for the user with a plurality of features displayed on the potential connection's recordation. The plurality of features may include the time remaining on the recordation, an x, a heart, a lightning bolt, a flag, and a change your mind icon. The potential connection's recordation may begin playing on a continuous loop. The potential connection's recordation may have the information provided by the connection including but not limited to name, age, occupation, and distance from the user overlayed on the recordation.

The interface may display a heart icon. The heart icon may indicate the user's interest to the potential connection's profile. In an embodiment, the heart icon may reveal a plurality of interest tiers. The plurality of interest tiers may include a primary heart indicating “Like” and a secondary heart indicating “Powerplay.” There may be a tiered membership structure. The primary heart may be available to all users. The secondary heart may only be available to users with the senior tier. The secondary heart may suggest greater interest towards the potential connection from the user in comparison to the primary heart. However, the like options may include other like features not listed herein. Features suggesting a senior tier may be modified throughout the duration of the application.

The System may register initiation of a heart icon indicating interest by the user towards the connection. The System may generate a “match” screen if the potential connection has already indicated interest towards the user. The “match” screen may not be generated if the potential connection has not indicated interest towards the user. However, the potential connection may indicate interest towards the user at a later time which the System may notify the user of the potential connection's interest. The user may have a limited number of connections made per week or a limited number of In-App recorded media views per week based on which limit is achieved first. However, a user operating under a senior tier may have an unlimited number of In-App recorded media views per day.

A senior message feature icon may be present on the screen. The senior message feature icon may only be available to users operating under the senior tier. The senior message feature may provide users with the option to message potential connections before the other party has shown interest in the user. The senior tier feature may be labeled under a different name in the application such as VIP, high-level, or paid tier/user.

The x icon may be present on the aforementioned screen. The x icon may indicate disinterest by the user towards the potential connection. The x icon may remove the potential connection's In-App recorded media from the user's interface. The potential connection may be removed from the user's feed permanently. Another button/feature may be used to block certain users from appearing on a user's feed.

The System may provide an undo feature (for example, represented as the “Change your mind?” icon). The “Change your mind?” icon may be present on the screen. The System may recognize initiation with the “Change your mind?” icon and may generate a pop up confirming the user is converting their selection from showing interest to showing disinterest. This may remove the potential connection from the user's feed permanently. The System may recognize the conversion of disinterest to interest using the undo feature. The undo feature may be available to users with a senior tier.

The System may recognize the option to flag the potential connection. Actuation of the flag icon denotes that the user determined the potential connection's profile to display inappropriate content or illegitimate information.

Mutual interest between the user and the potential connection may generate a “Match” overlay. The “Match” overlay may exhibit both the user and the connection's thumbnail. The thumbnails may be overlayed with the type of “like” the participant sent. The types of likes may be limited to the primary heart indicating “like” or the secondary heart indicating an increased level of interest compared to a “like.”

In some embodiments, the invention of the present disclosure may be a System configured to match a user's geographical data with another user's geographical data where each user is further matched by a specified age range. In an embodiment, the System may be configured to store data of the user's identifying information. The identifying information may be displayed on the user's profile where other users may be given notice of the user's identifying information. The System may enable In-App recorded media of the users, functioning as both a more efficient means of sorting through potential users and a safety feature. The System may not allow upload of In-App recorded media. The System may connect users through an algorithm which uses geographical data and age data. The System may be configured to enable users to decide whether they choose to connect. Following connection, the System may enable communication between the users.

In an embodiment, a user who has distributed all their “likes” may still make connections if a potential connection had previously liked the user. The System may provide the user with a limited amount of time to indicate interest in potential connections that have indicated interest. This time may correspond with the user's membership tier. For example, users operating under the “Basic” tier may have 48 hours, those operating under the “Plus” tier may have 72 hours, and those operating under the “Premier” tier may have 96 hours to indicate interest in potential connections that have indicated interest in said user. However, the time to respond based on a corresponding membership tier may be modified by the administrator.

Referring to FIG. 8, the System may display a user's profile from the perspective of potential connections in the profile interface. The interface may auto-play the user's recordation in a continuous loop. The System may pause the recordation when it registers a tap on the screen of the user's device. The System may register a secondary tap where it will resume the In-App recorded media. The view of the user's profile from the perspective of a potential connection may include an overlay with features. The features may include how much time is left in the recordation and name, age, gender identity, and occupation. The System may register a user navigating on the interface to access additional information provided such as but not limited to: the user's location and what the user is “looking for.” The user's photos and bio may also be provided. The overlay may include “edit” icons next to the photos and bio. The user may engage with the edit icon to modify their photos or bio.

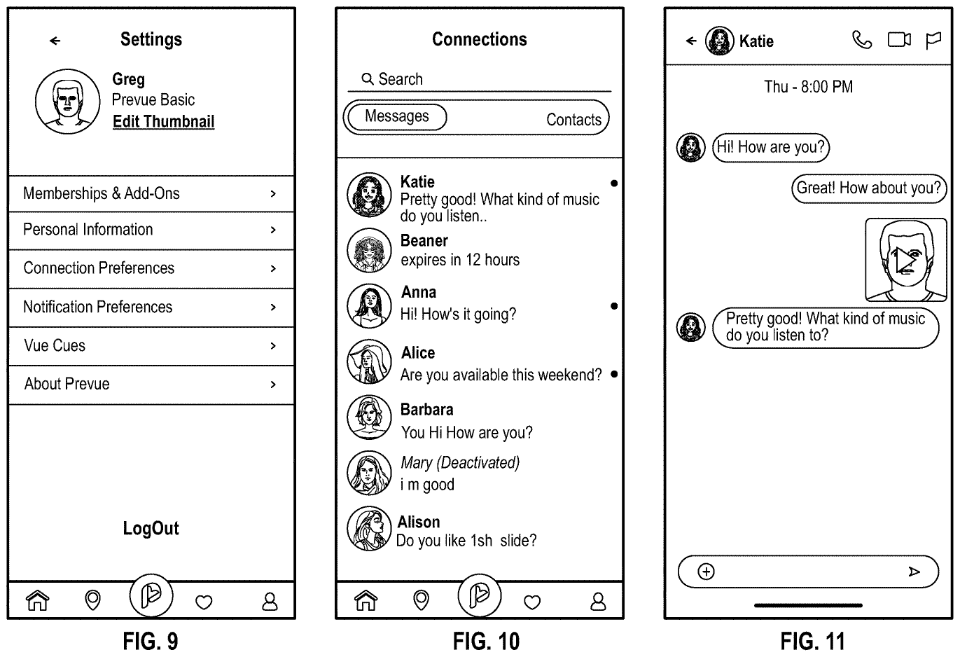

The profile module may have a settings icon in the overlay. The settings icon may direct the user to a settings interface. Referring to FIG. 9, the settings interface may display the user's profile picture, name, and membership status. The settings interface may provide a “log out” icon. The user may log out of their profile upon engagement with the “log out” icon. Upon engagement with the “log out” icon, a log out confirmation may be generated. The log out confirmation may ensure to the application the user intends to log out of their account.

The settings interface may provide the user with a plurality of options. The plurality of options may include but are not limited to Memberships & Add-Ons, Personal Information, Connection Preferences, Notification Preferences, a plurality of tutorials, and About the In-App recorded media. Upon selection of one of the plurality of options, the respective interface may be generated and displayed.

The System may recognize initiation with the Personal Information option in the settings interface. The Personal Information page may be generated. The Personal Information may have text fields for the user's personal information including but not limited to: display name, email, birthday, gender, occupation, home location, password, and deactivation/delete account. The System may allow the user the option to edit some text fields and not others. In a further embodiment, the System may allow editing of the text fields email, gender, and occupation. The user may not edit the text fields display name, birthday, or home location. However, the ability to modify the text fields in the personal information module may change throughout the life of the application.

The System may register initiation with the email text field to replace the email address provided. Doing so may also change the user's log in associated email.

The System may register initiation with the gender text field. The System may generate the gender identity interface that was provided during onboarding. The user may modify the interface and once saved, may be generated back to the settings personal information interface.

The user may engage with the occupation text field. The application may generate the same occupation interface that was provided during onboarding. The System may register modifications to the interface and once saved, may be generated back to the settings personal information interface.

The System may recognize initiation with the password text field. The application may generate a “Change Password” screen. The user may engage with a text field where a keyboard may appear. The text fields may include but are not limited to “Current Password,” “New Password,” and “Confirm Password.” The System may recognize the user's current password in the “Current Password” text field. The System may allow the user to create a new password which said user may enter into “New Password” and “Confirm Password.” The System may recognize initiation with the “Change Password” icon where the application will verify the passwords recited match and update the database. The new password created may be at least 8 characters, including 1 uppercase letter, 1 lowercase letter, and 1 number, however these qualifications may change throughout the life of the application. The System may generate the user to the “Personal Information” homepage. The field may show a “weak”, or “strong” password depending on the amount of uppercase, lowercase, numbers, and symbols in the password. The field may also consider if a user's name is in the password.

The “Personal Information” page may have a “Deactivation/Delete Account” text field. Initiation with the text field may take the user to an interface giving them the option to temporarily or permanently delete the account. The System may relay the user to the “Personal Information” page.

The settings interface may include “Connection Preferences.” The “Connection Preferences” interface may include “Relationship Type” and “Show me” text fields. Engaging with the “Relationship Type” edit icon may take the user to the “Looking for” interface. The System may recognize updates to the user's “Relationship Type” and return the user to the “Connection Preferences” interface.

The System may recognize initiation with “Connection Preferences” and may take the user to the “Show me” interface. The System may enable the user to update their gender identity preference(s) and age range preference. The System may confirm and relay the user to the “Connection Preferences” interface.

The settings interface may include “Notifications.” The “Notifications” may include switches for “New Connection,” “New Message,” “Direct [In-App recorded media],” and “Audio/Visual Calls.” The System may recognize the user sliding the switch to the right to turn on the respective option or sliding the switch to the left to turn off the respective option. “New Connection” may notify the user when a potential connection “likes” them back. “New Message” may notify the user if they receive a message from a potential connection. “Direct [In-App recorded media]” may notify the user of a new video from a potential connection. “Audio/Video Calls” may notify the user of a potential connection calling them using the application's phone call feature. Some features may allow a user to set up mobile, email, or text notifications to notify the user about “likes”. Users may also toggle notifications off if desired.

The Settings interface may include a plurality of tutorials The System may register a plurality of tutorials option to be taken to a page showcasing various thumbnails. The System may recognize engagement with a thumbnail which may generate a video. The video may provide tips for the user in utilizing the application to yield results. The System may recognize initiation with the back arrow to relay the user back to the settings main screen.

The Settings interface may include “About.” The interface may educate the user about the application from this interface. “Terms and conditions” may also be included in this screen.

The System may receive potential connections and present them on the connections interface, as shown in FIG. 10. The System may notify the user of a new connection or new message on the connections interface of the bottom menu. The connections interface may include a search bar. The connections interface may include a “messages” module and a “contacts” module. The System may generate a messages module. The messages module may include connections made by the user, or if no connections have been made, the messages tab may be empty. The System may recognize initiation with the search bar which may generate a keyboard. The keyboard may allow the user to search a contact name. The System may present filtered results during the search. The System may present a connection if both the user and the potential connection like each other. Upon connection, the System limits the amount of time users have to message each other. The amount of time may depend on the associated tier type. The System may present the time left to message under the connection's name. The System may recognize a deletion function on the message thread.

The System may recognize connections on the messages module. Initiating contact with a connection may present the user with a message thread between the user and the connection, as shown in FIG. 11. The message thread may present the connection's name at the top of the screen. The message thread may have a phone icon, a video icon, and a flag icon. The phone icon may facilitate a calling function between the user and the connection. The calling function may allow the device of one user to call the device of another user. The video icon may facilitate a video call between the device of one user and the device of another user. The flag function may allow one user to notify the application of inappropriate or offensive content. The System may register communication between the user and the potential connection. The System may recognize initiation with the text field where a keyboard may be generated. The keyboard may enable “emoji” selection. The System may display a “send” icon to direct a message to a potential connection. The System may further display the “+” icon to record a direct In-App recorded media for a potential connection. The video call interface may allow users to flip the camera, mute/unmute, hide/show, video, and end call. The System may enable a limited amount of time to utilize the video call interface based on the membership purchased. A warning may appear some time before the video call interface time has been used up.

The System may generate a “contacts” interface. The “contacts” interface may utilize a search feature. Initiating with the “search” text field may generate a keyboard. The System may recognize the name of a contact in the listed connections to easily access that contact. The contacts interface may sort the contacts alphabetically by default. The contacts interface may also sort by most recently matched. The System may recognize connection of a potential connection's profile thumbnail to view a potential connection's profile. The System may receive a notification of a potential connection's message. The notification may show up next to the potential connection's name. The System may set a limit to the time users have to first respond to a new connection. The limited time may be determined by the senior tier. A connection may be removed from the contact list if neither party messages each other before the limited time is up. The interface may be empty if there are no connections present. Some embodiments may allow users to make recommendations to other users if they are found in their contacts.

Selection of a profile in the connection interface may induce the System to generate said connection's profile on the user's device. A connection's profile may present a connection's inputted information, including but not limited to name, age, gender identity, and occupation. The profile may present any variation of a user's inputted information. The connection's profile may display a flag icon. The flag icon may be utilized for a user to report or flag content on the connection's profile as inappropriate or offensive. The page may also include the potential connection's location and the qualifications inputted under “looking for.” The System may relay text from user to user by utilizing a message icon.

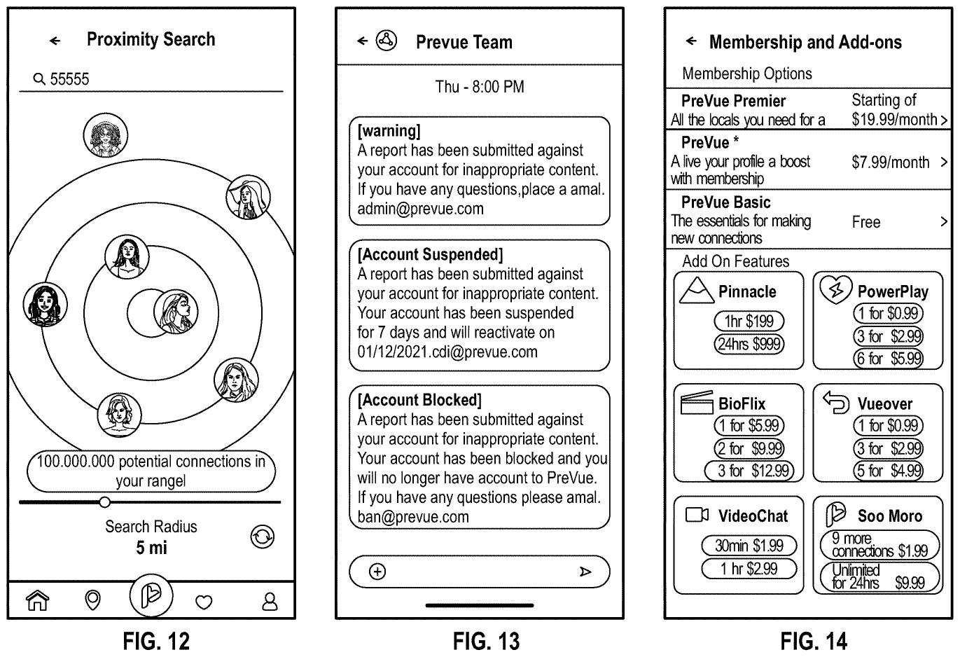

Referring to FIG. 12, the System may include a proximity search tab. The proximity search tab may allow a user to utilize the location services in the application. For example, the System may recognize a change in the user's location or search within the location radius. In a further embodiment, location services may enable other uses. The proximity search feature may present the location chosen by the user. The user may engage with the proximity search feature where a keyboard may be enabled for the user to type in a new location. The System may provide a radius preference. The radius preference may include a sliding scale where the System may recognize a range from 0.5 mile to 100 miles. The default radius preference may be some number of miles. The System may enable a change in location and a search for connections in any location based on the membership.

The radius preference may present a number of potential connections. The System may refresh this search with a new search or a refresh icon. The System may register a tap on the thumbnail of the potential connection. The potential connection's In-App recorded media card may appear where the user may be presented with the potential connection's inputted information. The user may return to the proximity search. The System may present a text box showing the amount of potential connections in the user's search. The user may be alerted to turn on location services on this application from their personal device to utilize this feature. In a further embodiment, an animation feature is enabled when the radius feature is refreshed or adjusted.

There may be a In-App Recorded media module. The In-App Recorded media module may be utilized to create a recordation. The recordation may be some length of time. For example, the recordation may be 22 seconds long or any number aimed at maximizing focus with a user's attention span. The System may display this video on the user's profile. In a further embodiment, the System may present this video to potential connections. The System may present this video to more than one potential connection. The System may further allow download of the recordation produced in the application onto their personal device.

Referring to FIG. 13, the System may include a team communication interface where two-way communication may be facilitated between a user and an administrator. Referring to FIG. 14, the System may include a tier interface where a user may view available tiers and opt into one or more of the said tiers.

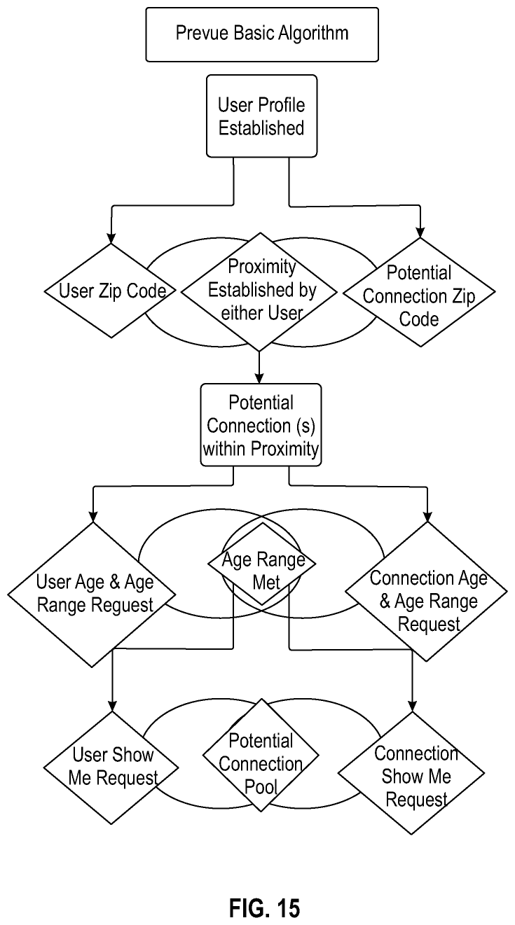

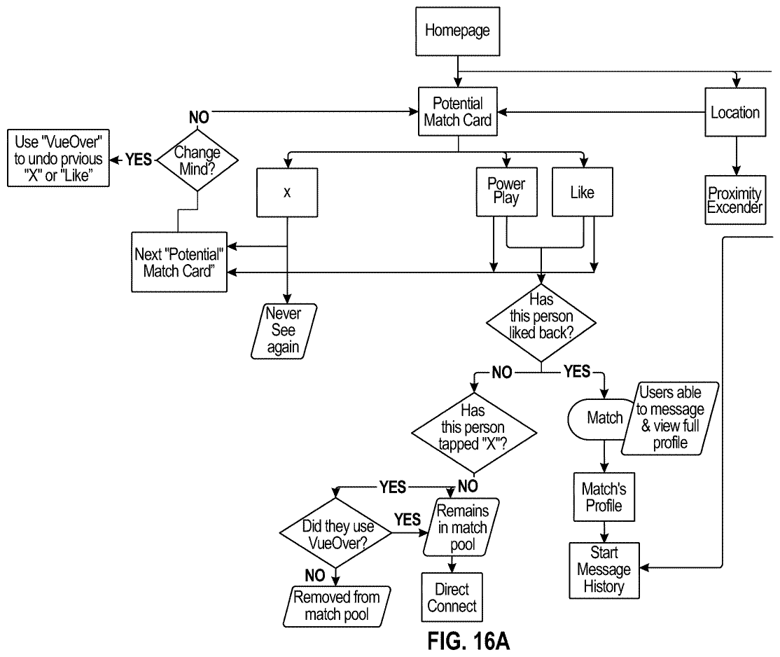

Referring to FIG. 15, the System may enable connections based on an algorithm. The algorithm may detect a user profile has been established. The user profile may be stored in a server database, wherein the user profile includes an associated zip code. Accordingly, the processor may evaluate the proximity of one user to a second user based on the geographical distance calculated between a first user and a second user's zip codes. Secondary users that fall outside the scope of the pre-determined proximity threshold may be removed from the potential connection bin of the first user. Thus, secondary users within the proximity threshold may next be evaluated for age. The processor may evaluate the age of one user to a second user based on the age preference given by the first user. Secondary users that fall outside the scope of the age preference threshold may be removed from the potential connection bin of the first user. Finally, the bin may again be depleted based on whether or not the secondary user engages with the first within the given duration of time.

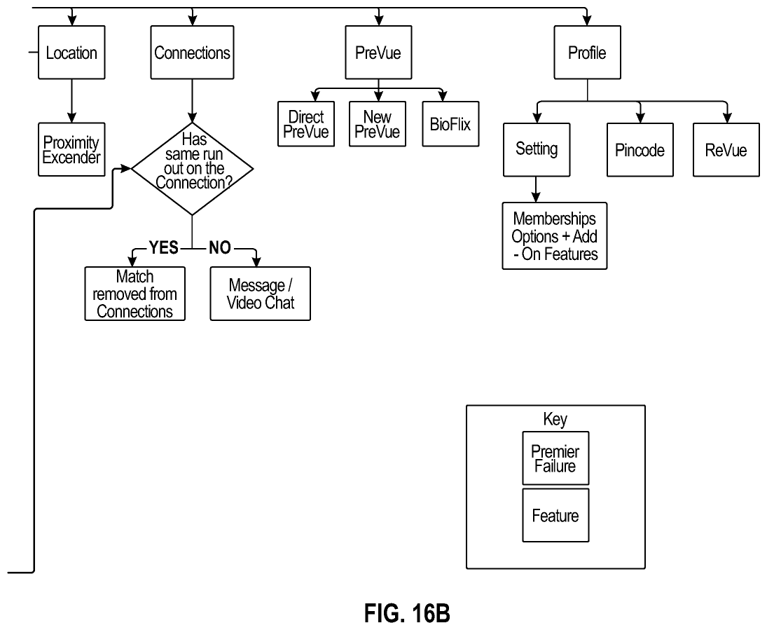

Referring to FIGS. 16A-16B the System may include one or more paths of navigation across the various modules and/or interfaces. The homepage may include the modules for a Potential Match Card, Location, Connections, an In-App recorded media, and a profile. The user's profile may include a settings module which allows for membership options and add-on features. The location module may enable matches through a proximity threshold and may be further enabled through a proximity extender. The System may recognize a potential match card through two manners: location and the change mind feature. A Potential Match Card may enable an x response, a like, or in a senior tier, a powerplay. The System recognizing an x response may configure the potential connection's profile to never display for the user again. However, when the next “potential connection” card displays, the user may change their mind by selecting the undo feature where a user may change the response to either an x response or a like response. The System may recognize a like response. The System recognizing a like response may lead to a connection if the potential connection has responded back with a like. The connection may lead the System to recognize communication between the primary user and secondary user. The System, not recognizing a like response, may further recognize an x response by the secondary user. An x response by the secondary user may remove the primary user from the secondary user's connection pool. However, the secondary user may undo their initial selection, which may then lead the primary user to remain in the secondary user's pool. The System may recognize communication between users where one user has not yet liked the other user through a senior message feature. The connections module may be enabled allowing users who connected to message or video chat between the user's respective devices if the time threshold has been met. If the time threshold has been met before one user messages another, the connection may be removed from the connections interface. The In-App recorded media module may enable direct In-App recorded media or a new In-App recorded media.

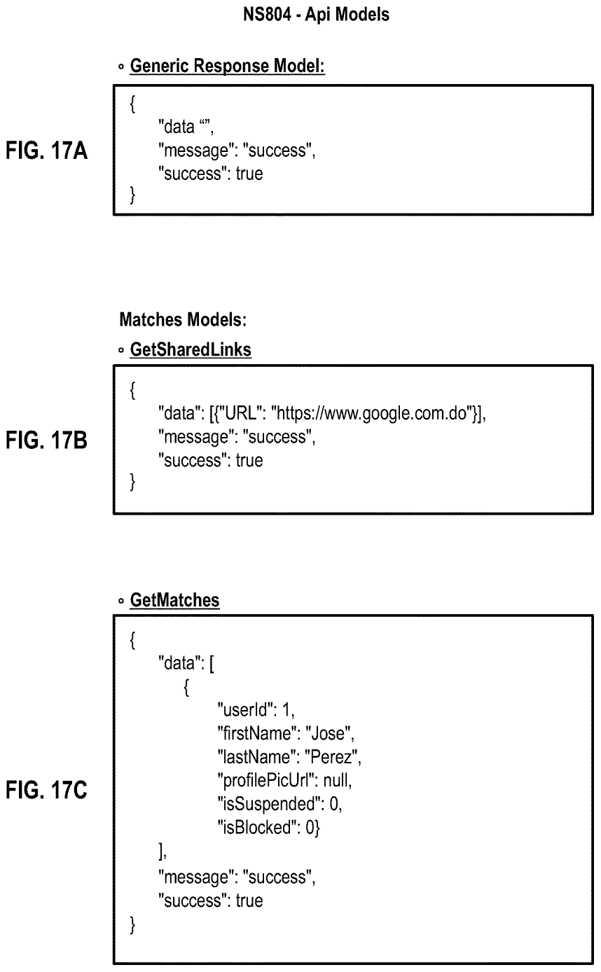

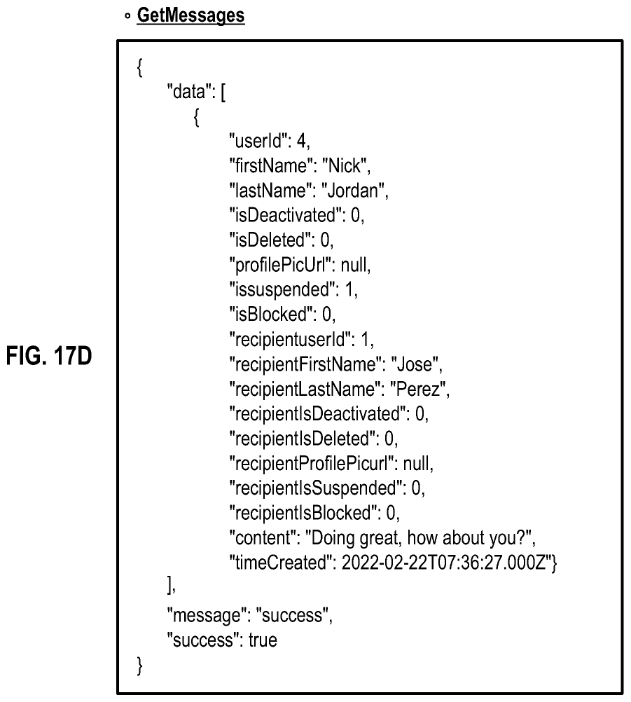

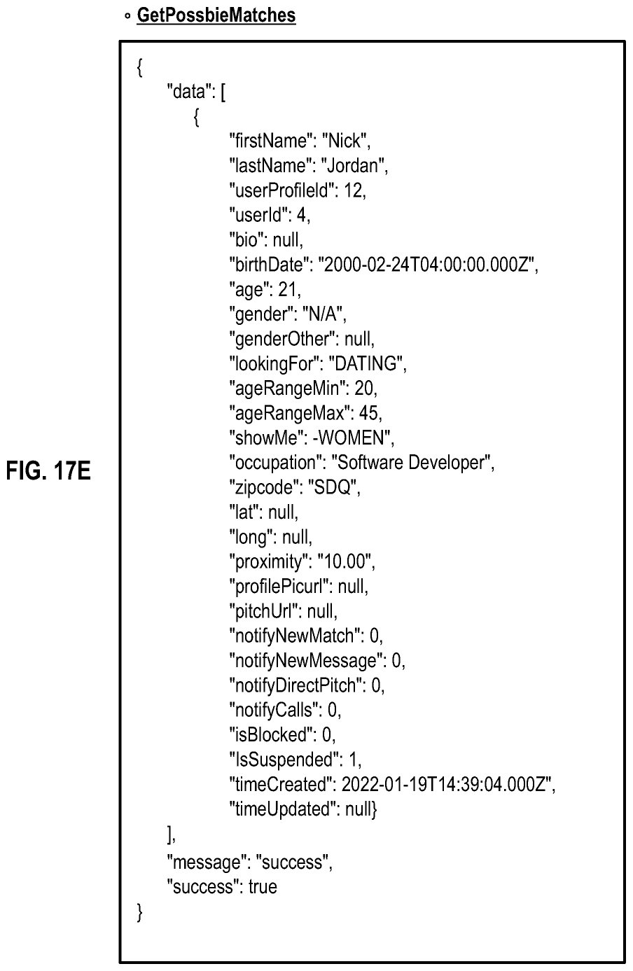

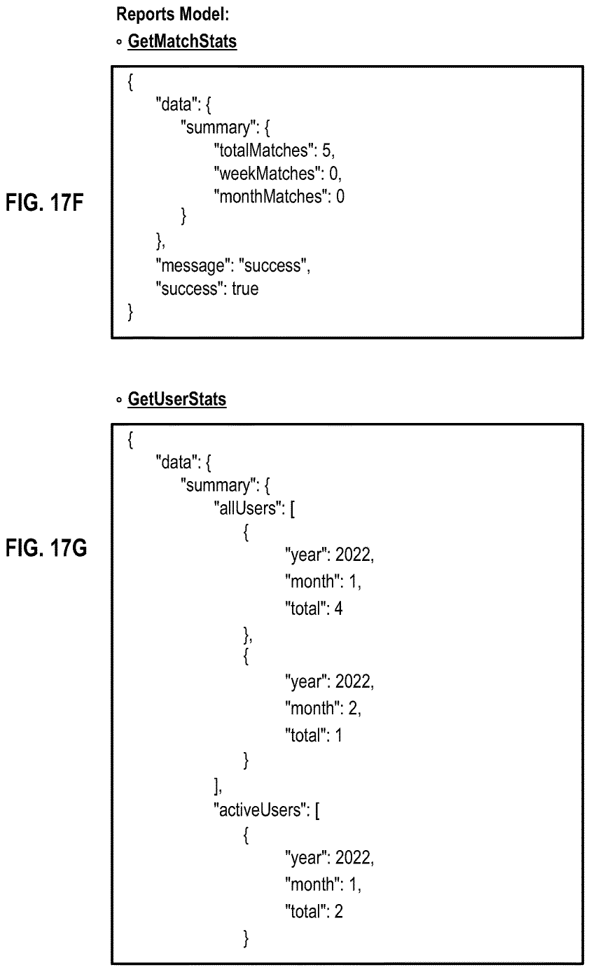

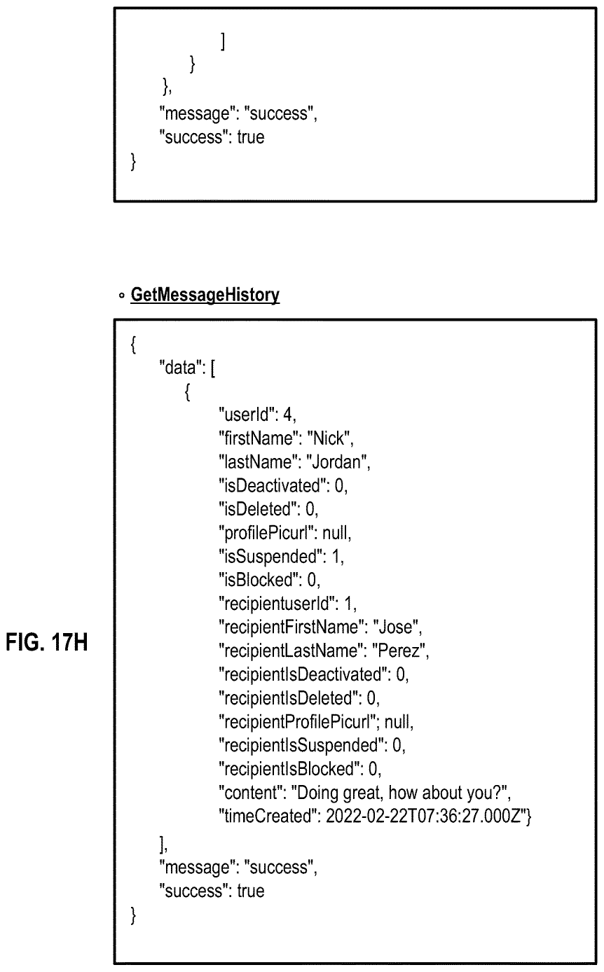

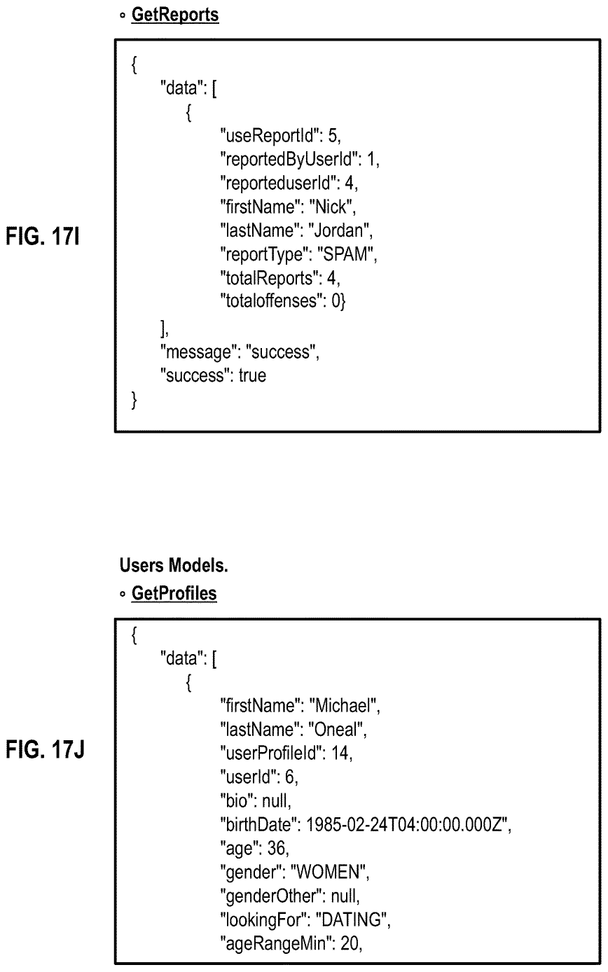

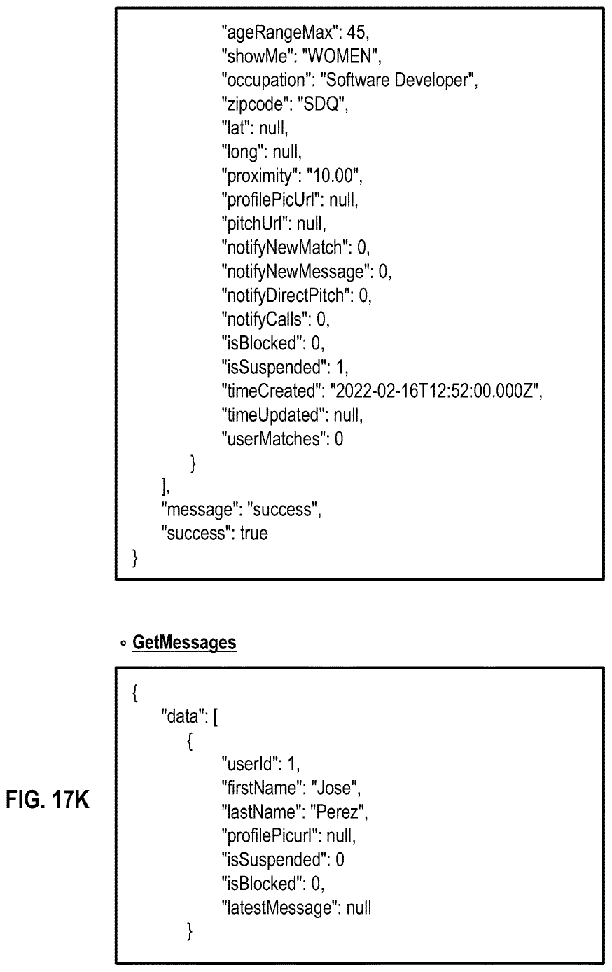

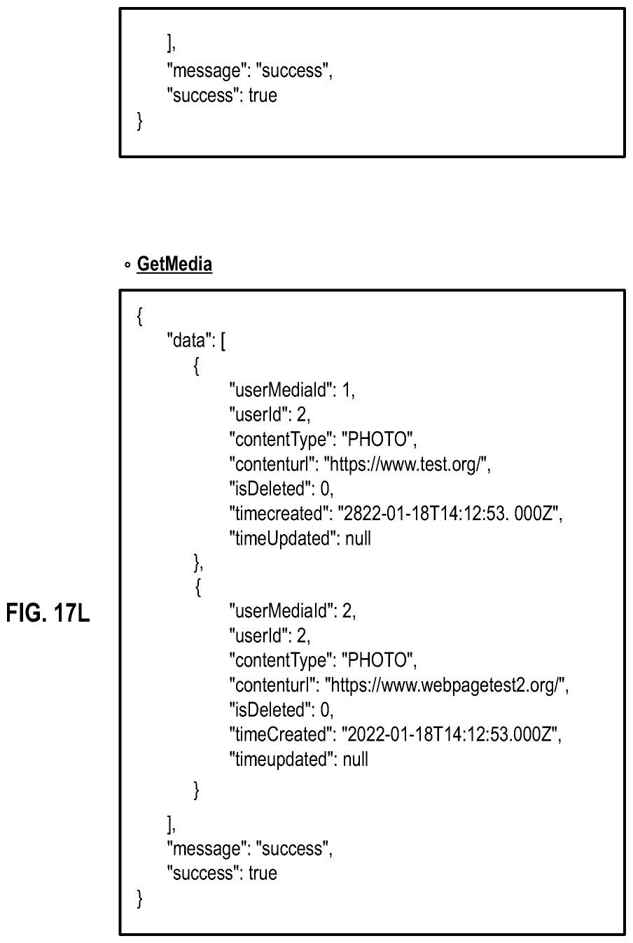

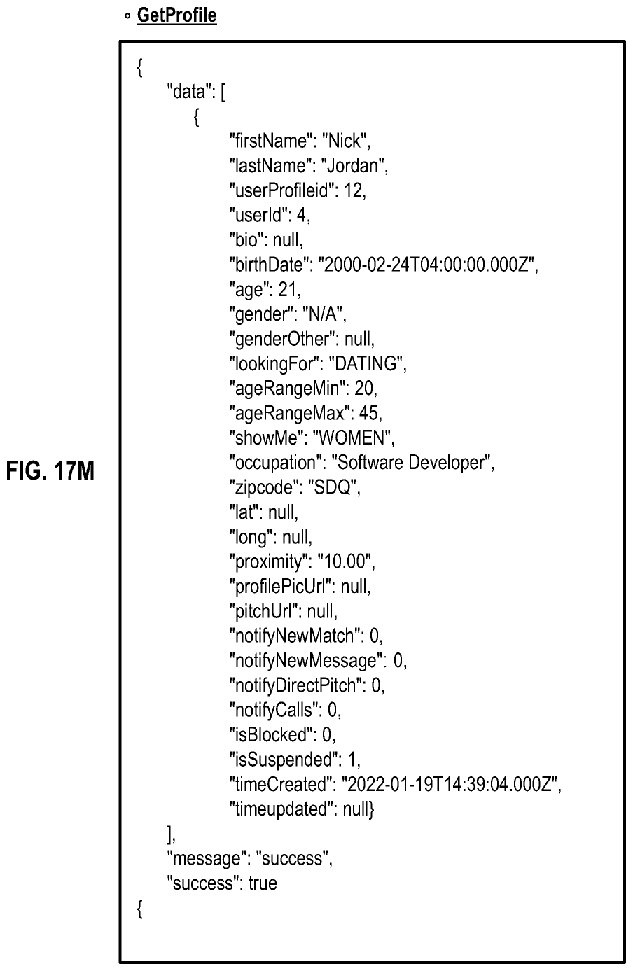

FIGS. 17A-17M depict code snippets correlating to the various actions, modules, interfaces, software elements, application aspects, and other features described herein.

While this invention has been described in conjunction with the embodiments outlined above, many alternatives, modifications and variations will be apparent to those skilled in the art upon reading the foregoing disclosure. Accordingly, the embodiments of the invention, as set forth above, are intended to be illustrative, not limiting. Various changes may be made without departing from the spirit and scope of the invention.

### II. Safety and Trust Measures

Dating applications have created a subset of “safety” problems. With an increase in photo editing quality, users may edit or “filter” their profile, images, and videos, some to the point where the profile may be considered forged. Users may also import photos that depict someone else entirely, falsely “leading on” other users. Due to the highly personal aspect of this application, where users are constantly meeting new people and opening themselves up to rejection, users trust Administrators to keep them safe. A distrust between users and the Administrators may develop if nothing is done to mitigate this safety issue. The following safety and trust measures may also be implemented in several other applications involving video safety and security concerns.

The present disclosure provides a method of preventing “forged” profiles by preventing users from uploading edited videos or pictures to their profile. This may be applicable to several social networking applications and is not limited to dating applications.

In some embodiments, the invention of the present disclosure may be a System configured to match a user's geographical data with another user's geographical data where each user is further matched by a specified age range. In an embodiment, the System may be configured to store data of the user's identifying information. The identifying information may be displayed on the user's profile where other users may be given notice of the user's identifying information. The System may enable In-App recorded media of the users, functioning as both a more efficient means of sorting through potential users and a safety feature. The System may not allow upload of In-App recorded media. The System may connect users through an algorithm which uses geographical data and age data. The System may be configured to enable users to decide whether they choose to connect. Following connection, the System may enable communication between the users.

It would be desirable to provide a system configured to mitigate the safety deficiencies through the introduction of profiles comprising recorded videos. For example, recorded videos are less likely to be edited. It may be further desirable to provide a system wherein the recorded video is created directly within the application's interface. It would be yet further desirable to provide a system adapted to increase a user's intrigue while taking their attention span into account. For example, users may be provided a glimpse into what the potential connection is like in “real life,” more than a list of identifying features could.

In some embodiments, the application system may not recognize or accept uploaded videos through traditional file uploads. This means that users may not be able to upload pre-recorded video files directly to their profiles. Instead, the system may only allow the creation of in-app recorded media within the application itself. By limiting video uploads to in-app recorded media, the application aims to enforce safety features and prevent any modifications or misrepresentations of a user's personal attributes. This helps ensure that the user's profile accurately reflects their true self in relation to their in-person identity.

In some embodiments, the in-app recorded media may include both audio and visual components, allowing users to create authentic and unaltered content that showcases their genuine personality and appearance. By utilizing the application's recording feature, users can capture real-time videos that are more reliable and consistent representations of themselves. By implementing this approach, the application strives to enhance user safety and maintain the integrity of user profiles. It mitigates the risk of users editing or manipulating their videos to present an inaccurate or misleading portrayal of themselves, reducing the likelihood of disappointment or deception during in-person interactions. The focus on in-app recorded media aligns with the application's commitment to fostering genuine connections and promoting transparency among users. By utilizing the built-in recording functionality, users can showcase their true selves and engage with others who share similar intentions of forming meaningful connections based on authenticity and trust. Some embodiments may include users uploading images of IDs to verify that the user in the videos is the same as the user using the account. AI/ML methods may be used to determine a facial match between the uploaded ID and the user's uploaded videos.

In addition to preventing users from uploading edited videos or pictures to their profiles, there are several other measures that dating applications can take to enhance safety and build trust among their users. Some other safety measures may include user verification, photo authentication, reporting and moderation, safety education, privacy controls, AI-driven risk analysis, user feedback, and codes of conduct.

User verification is a critical aspect of the application to ensure that profiles belong to real individuals, enhancing safety and building trust among users. There are several methods that dating applications can employ for user verification.

The application may implement a robust photo verification system to enhance safety and build trust among users. Photo verification involves utilizing advanced technologies and methods to ensure the authenticity of profile pictures uploaded by users.

The process of photo verification begins with the application analyzing uploaded images using sophisticated algorithms. These algorithms can examine various elements of the photo, such as pixel patterns, metadata, and image consistency, to identify potential signs of manipulation or tampering. By detecting alterations in the images, the application can flag profiles that may have forged or misleading photos.

To further ensure authenticity, the application may compare the uploaded profile pictures with original images provided by users during the verification process. This comparison may help to verify that the images being used on the profile are consistent with the originals, reducing the risk of users using deceptive or misleading visuals.

In addition to algorithmic analysis and image comparison, user reporting may play a crucial role in the photo verification process. Users can be encouraged to report suspicious or potentially forged profile pictures they come across. The application's moderation team can then review these reports and conduct further investigations as necessary.

Some embodiments may include a photo/video verification system. By implementing a robust photo verification system, the applications may significantly reduce the likelihood of forged profiles and enhance the overall trust and authenticity of the platform. This helps create a safer and more reliable environment for users to connect and interact with others.

Some embodiments may use email verification. During the registration process, users are required to provide a valid email address. The application sends a verification email with a unique link, and users need to click on that link to confirm their email address. This step ensures that the provided email is valid and associated with the user, increasing the likelihood of genuine profiles.

Other embodiments include phone number verification. Users can be asked to verify their phone numbers by entering a verification code sent via SMS. By confirming ownership of the provided phone number, this method adds an extra layer of authenticity and helps reduce the number of fake profiles.

For a more comprehensive verification process, the applications may implement identity verification through official documents. Users may be required to upload a scanned copy of their government-issued ID, such as a driver's license or passport. The application can then compare the provided information with the user's profile details to verify their identity.

In addition to these methods, the application may allow users to sign up or link their accounts with other social media profiles. This integration can provide additional verification, as users are less likely to create fake profiles using their real social media accounts.

In a preferred embodiment, to further enhance trust, the application may introduce video verification. Users may be prompted to record a short video of themselves, confirming their identity and demonstrating that they are a real person. The application can use facial recognition technology to compare the video with the user's profile pictures, adding another layer of authenticity.

Implementing user verification measures such as email verification, phone number verification, identity verification, social media integration, and video verification can significantly reduce the number of forged profiles on dating applications. By ensuring the authenticity of users, these applications can create a safer and more trustworthy environment for their user base.

Some embodiments may include reporting by users and moderators within the app. These systems allow users to report any suspicious or inappropriate behavior, profiles, or messages they encounter, while also enabling the application to take appropriate actions to address such concerns.

The applications may provide a user-friendly interface that allows individuals to easily report any concerning activity they come across. This interface may be intuitive and accessible, ensuring that users can quickly navigate and understand how to submit a report. Within the reporting feature, users may be given the option to specify the nature of the issue, such as fake profiles, offensive content, harassment, or other violations of community guidelines.

Once a report is submitted, it becomes crucial for the dating application to have an efficient and responsive moderation system in place. A dedicated team of moderators can review the reported content and investigate the issue further. These moderators may possess the necessary training and expertise to handle different types of reports, ensuring fair and consistent decision-making.

The moderation team may follow established guidelines and policies to determine the appropriate actions to be taken. Depending on the severity and nature of the reported content, these actions can range from issuing warnings to temporarily suspending or permanently banning the reported user. In some embodiments, the moderation may communicate the outcome of the report to the user who submitted it, ensuring transparency and accountability. The outcome will also be communicated to the user who was suspended or banned.

Regular monitoring and evaluation of the reporting and moderation system are crucial to identify and address any shortcomings. Feedback from users, as well as data analysis on reported incidents, can help identify trends or patterns that require attention. By continuously improving the reporting and moderation processes, dating applications can effectively address safety concerns and maintain a trusted environment for their users.

A well-designed reporting and moderation system empowers users to report concerns, facilitates thorough investigations by a dedicated team of moderators, and enables appropriate actions to be taken against violators. Such systems may play a vital role in maintaining safety, trust, and user satisfaction within dating applications.

Safety education may be included in some embodiments. This may allow the application to promote user awareness and provide guidance on safe online dating practices. By offering educational resources and information, dating applications can empower their users to make informed decisions and protect themselves while using the platform.

The application may also implement safety education through various means. They can provide in-app tutorials, blog articles, or even video guides that cover topics such as recognizing common scams, identifying signs of catfishing, and understanding privacy settings. These resources can be easily accessible within the application, ensuring that users have access to valuable information right at their fingertips.

The educational materials may cover a wide range of safety topics relevant to online dating, including how to protect personal information, how to spot and report suspicious behavior, and how to navigate consent and boundaries in online interactions. It's important to provide practical tips and actionable advice to help users make informed decisions while engaging with others on the platform.

To ensure the effectiveness of safety education, the applications may incorporate interactive elements into their educational resources. For example, they can include quizzes or scenarios that allow users to test their knowledge and understanding of safe dating practices. Gamification techniques can be used to engage users and make the learning experience more enjoyable and memorable.

Regular reminders and prompts about safety practices may also be incorporated into the application's user interface. This can include notifications that highlight important safety tips, encourage users to review their privacy settings, or remind them to report any suspicious activity. By integrating safety reminders into the user experience, the application can reinforce the importance of user safety and encourage responsible online behavior.

Safety education aims to empower users with knowledge and tools to navigate the online dating landscape safely. By providing accessible and comprehensive educational resources, applications can help users understand potential risks, adopt protective measures, and make well-informed choices, ultimately fostering a safer and more secure environment for everyone involved.

A preferred embodiment may include privacy controls within the application. The privacy controls would be designed to give users the ability to manage their personal information and the visibility of their profiles according to their preferences and comfort levels. One important aspect of privacy controls is profile visibility. Users may have the option to choose who can see their profile, whether it's limited to approved matches, hidden from specific individuals, or made visible to everyone. This empowers users to have control over who can access their profile information.

Another crucial element is photo visibility. Privacy controls can provide users with the ability to choose the visibility of their profile photos and videos. They may opt to display their photos only to matches or hide them from certain individuals. This feature allows users to maintain a level of privacy and control over their visual representation on the platform.

Privacy controls can also encompass messaging preferences. Users may have the option to manage who can send them messages, whether it's limited to matches only or open to all users. This helps users avoid unwanted messages and maintain a more secure and comfortable messaging experience.

Location privacy may be included in the privacy controls. The applications may allow users to customize their location settings and choose how precise their location information is shared. This feature ensures that users have control over how their geographical data is used and displayed to others on the platform.

In some embodiments, privacy controls can extend to data management. Users may have the ability to manage their personal data, including the option to delete or modify information on their profile. In a preferred embodiment, clear and transparent privacy settings are provided, allowing users to understand and manage the data collected by the application. Algorithms may use this data to provide recommendations to users about potential matches.

By offering robust privacy controls, the application empowers users to tailor their privacy settings according to their preferences. These controls contribute to a safer and more secure environment, where individuals feel confident in sharing their personal information and engaging with others on the platform.

In some embodiemnts, AI-driven risk analysis is a powerful tool that certain applications may employ to enhance safety and security within their platforms. By leveraging advanced artificial intelligence algorithms, these applications can analyze user behavior, profile information, and interactions to identify potential risks and suspicious activities.

Using AI-driven risk analysis, the applications may detect patterns and anomalies that may indicate fraudulent or malicious behavior. The algorithms can analyze various factors such as message content, frequency of interactions, profile consistency, and user-reported incidents to assess the level of risk associated with a particular user or interaction.

One aspect of AI-driven risk analysis is the identification of potential fake or fraudulent profiles. By analyzing profile information, image consistency, and user behavior patterns, the AI algorithms can flag suspicious profiles that may be using false information or engaging in deceptive practices. This helps protect users from falling victim to scams or catfishing.

In some embodiments, AI algorithms can monitor user interactions and identify potential harassment or abusive behavior. By analyzing message content, sentiment, and contextual cues, the algorithms can detect patterns that indicate inappropriate or harmful communication. This allows the application to intervene and take appropriate actions to address such behavior and ensure user safety.

Furthermore, AI-driven risk analysis can contribute to detecting and preventing online scams. By analyzing user behavior, transaction patterns, and reported incidents, the algorithms can identify suspicious activities related to financial exploitation or fraudulent schemes. This helps protect users from potential financial harm or identity theft. This may be useful in other applications and is not limited to dating applications.

It's important to note that AI-driven risk analysis should be implemented ethically and with appropriate privacy safeguards. User data should be handled securely and in compliance with relevant privacy regulations to ensure user trust and confidence.

By leveraging AI-driven risk analysis, the application can proactively identify and mitigate potential risks, fostering a safer and more secure environment for their users. This technology enhances the overall user experience by reducing the chances of encountering fraudulent profiles, abusive behavior, or financial scams, and ultimately contributes to building trust and confidence within the application community.

User feedback and ratings play a crucial role in shaping the development and enhancement of the dating application. The platform incorporates various features to encourage users to provide feedback and rate their experiences, ensuring their voices are heard and their opinions are valued.

In some embodiments, a dedicated feedback section is available to users, providing an avenue to share their thoughts, suggestions, and concerns. This section may include a feedback form or an interactive survey that covers different aspects of the user experience. The application actively seeks user input to continuously improve and refine its services. This may include a rating system such as the one used by the apple app store or google play store.

By actively seeking and considering user feedback, the dating application can identify areas for improvement and implement changes that align with user preferences. Feedback can provide valuable insights into the user experience, such as the effectiveness of match algorithms, communication tools, or overall platform usability.

User ratings are another important aspect of the dating application's feedback system. Users are given the opportunity to rate their experiences, providing an overall assessment of their satisfaction with the platform. These ratings serve as a valuable indicator of user sentiment and help the application gauge its performance.

The application recognizes the importance of transparency and accountability when it comes to user feedback and ratings. Actions are taken to ensure that the feedback received is carefully analyzed, and appropriate steps are taken to address user concerns and implement necessary improvements. Regular communication with users regarding the actions taken based on their feedback helps foster trust and maintain a strong user community.

Community guidelines and a clear code of conduct are essential components of the dating application, ensuring a safe and respectful environment for all users. These guidelines outline the expected behavior and standards of conduct within the platform, promoting positive interactions and mitigating any potential risks or misconduct.

In a preferred embodiment, the dating application includes established comprehensive community guidelines that users are expected to follow. These guidelines define acceptable behavior and provide a framework for fostering a respectful and inclusive community. They cover various aspects, including communication etiquette, appropriate content, and guidelines for reporting violations. By setting clear expectations, the application creates a sense of accountability and helps maintain a positive user experience.

The code of conduct further reinforces the community guidelines by providing specific rules and standards of behavior. This document outlines the actions that are considered unacceptable within the dating application, such as harassment, discrimination, or the sharing of inappropriate or offensive content. It emphasizes the importance of treating others with respect, promoting consent, and upholding ethical standards.

To ensure compliance with the community guidelines and code of conduct, the dating application employs moderation systems and algorithms that monitor user interactions and content. This proactive approach helps identify and address any violations swiftly, ensuring a safe and enjoyable experience for all users.

In some embodiments, Regular communication of the community guidelines and code of conduct is performed to the users of the application. The application may provide users with a clear overview of these guidelines during the onboarding process and make them easily accessible within the app. Additionally, reminders and notifications can be sent periodically to reinforce the importance of adhering to these guidelines.

The application encourages users to report any violations they encounter, fostering a collaborative approach to community moderation. Reports are taken seriously, and appropriate actions are taken in response to reported violations, such as warnings, suspensions, or permanent removal of offending accounts.

By prioritizing community guidelines and a robust code of conduct, the dating application promotes a safe and respectful environment where users can connect and engage with confidence. These measures create a sense of trust, encourage positive interactions, and contribute to the overall well-being of the user community.

In some embodiments, the guidelines and code of conduct within the dating application may be periodically updated to reflect evolving needs, user feedback, and industry best practices. The application recognizes the importance of staying current and adapting to changes in the online dating landscape.

Updates to the guidelines may be driven by various factors. User feedback plays a crucial role in identifying areas that require clarification or improvement. By actively soliciting and considering user input, the dating application can address emerging concerns and enhance the guidelines accordingly.

Additionally, changes in societal norms and cultural contexts may necessitate updates to the guidelines. The application strives to maintain inclusivity and relevance, ensuring that the guidelines reflect diverse perspectives and promote an environment that is respectful and welcoming to all users.

Furthermore, advancements in technology and industry standards may impact the guidelines. As new features and functionalities are introduced, it is important to review and update the guidelines to address any associated risks or considerations. This helps maintain a secure and up-to-date platform for users.

When updating the guidelines, the application may follow a thorough review process. This may involve consulting with legal experts, industry professionals, and/or considering relevant regulations and guidelines. The application also communicates these updates to users through notifications or by prominently displaying the revised guidelines within the app.

By periodically updating the guidelines, the dating application demonstrates its commitment to providing a safe and positive user experience. These updates ensure that the guidelines remain relevant, effective, and responsive to the evolving needs and expectations of the user community.

### III. Algorithms

Some embodiments may include the use of AI/ML algorithms for matchmaking between users. Some of these algorithms may include the use of relationship-based matchmaking, age-based matchmaking, gender-based matchmaking, sexual orientation-based matchmaking, race/ethnicity-based matchmaking, etc. Some embodiments may scan, extract data from the videos uploaded by users and use that information with AI/ML algorithms to determine the best match based on several features/traits.

Some embodiments may use age-based matchmaking. Age is a fundamental factor in matchmaking, as individuals typically have preferences regarding the age range of potential partner. Users may specify a preferred age of their potential matches. Verification of this age may be done by adding a form of ID for each user to ensure they are inputting their real age.

Some embodiments may use gender or sexual orientation-based matchmaking. Matching based on gender and sexual orientation allows users to connect with individuals who align with their preferences and interests. The application recognizes that gender is not binary and provide users with a range of options to accurately represent their gender identity. This may include options such as male, female, non-binary, genderqueer, and more. By allowing users to choose their gender identity, the application can create a space where individuals can be seen and matched based on their self-identified gender. The application also acknowledges the diversity of sexual orientations to provide users with options to indicate their sexual orientation, such as heterosexual, gay, lesbian, bisexual, pansexual, and others. By including sexual orientation as a matching feature, the application can better align individuals with potential matches who share compatible sexual orientations. These features help users find matches who are more likely to be interested in and compatible with their gender identity and sexual orientation. They enable individuals to explore relationships and connections that align with their own unique identities and preferences, fostering a more inclusive and supportive environment within the dating application.

Location is a crucial factor in matchmaking as it plays a significant role in determining the feasibility and practicality of potential matches. The application may include location as a feature to help users connect with individuals in their vicinity or desired geographical area. Matching individuals based on their location allows for potential matches who are physically closer to each other. This feature is particularly important for users who prefer to meet and date people in their local area. By narrowing down the search radius, the chances of users finding matches who are within a reasonable distance is increased, making it easier to meet in person and potentially build a more meaningful connection.

Location-based matchmaking takes into account the practicality of a potential match. It considers factors such as commuting distance, availability for dates, and shared local experiences. By matching individuals who live or work in the same area, the application aims to facilitate smoother logistics for meeting up and foster shared experiences that can enhance the dating process. Location can also be relevant for users who have specific preferences or lifestyle considerations. For example, someone may prefer to connect with individuals who reside in the same city or neighborhood due to shared interests, cultural affinity, or the convenience of local amenities and activities. Matching based on location can help align individuals with similar lifestyles and enhance compatibility. While location-based matching often prioritizes proximity, some embodiments may include an application that also caters to individuals who are open to long-distance relationships. These platforms may provide features that allow users to search for matches in specific cities or even globally, enabling connections beyond their immediate geographical area.

It's worth noting that the degree of emphasis placed on location as a matchmaking feature can vary depending on user preferences and the nature/preferences of the user. Some users may prioritize local matches, while others may offer a broader range of options and flexible search criteria.

Matchmaking algorithms may also take into account relationship goals, education, profession, values, beliefs, physical attributes, and personality traits. These algorithms may compute a compatibility scoring to show users the most compatible partners based on these factors. These “compatibility scores” may be hidden or shown to the user. Some embodiments may include showing only senior tier users their compatibility scores.

When leveraging in-app recorded media for matchmaking purposes, the integration of advanced algorithms can significantly enhance the accuracy and effectiveness of the matching process. These algorithms can analyze various aspects of the media to identify potential compatibility between individuals.

One algorithm that could be employed is facial recognition. By analyzing the facial features and expressions captured in the in-app recorded videos, this algorithm can assess factors such as facial symmetry, emotional cues, and micro-expressions. It seeks to identify potential compatibility based on facial attributes associated with attraction, compatibility, or emotional resonance.

Another algorithm that can be utilized is speech analysis. By examining the audio recordings within the in-app media, this algorithm can analyze aspects such as tone, pitch, rhythm, and linguistic patterns. Through this analysis, it aims to identify qualities such as confidence, warmth, assertiveness, or even shared communication styles, providing insights into potential compatibility in interpersonal dynamics.

Additionally, emotional analysis algorithms can be employed to assess the emotional content expressed in the in-app recorded media. By recognizing and interpreting emotions such as joy, sadness, anger, or excitement, these algorithms aim to identify emotional compatibility between individuals. They can also detect emotional patterns or sensitivities that may indicate a higher likelihood of connection or understanding.

Interest and preference matching algorithms can analyze the content shared within the in-app recorded media to identify shared interests, hobbies, or preferences. Leveraging natural language processing and semantic analysis techniques, these algorithms extract key information and match individuals based on their common interests, thereby increasing the likelihood of compatibility and shared activities.

Personality profiling algorithms are another valuable tool in the matchmaking process. They analyze the in-app recorded media to assess personality traits such as extraversion, openness, conscientiousness, or emotional stability. By analyzing speech patterns, language use, and nonverbal cues, these algorithms generate personality profiles that can be used to match individuals based on complementary or compatible traits.

To provide a comprehensive assessment, compatibility scoring algorithms can be developed by combining the insights from multiple algorithms. These algorithms consider multiple dimensions, including physical attraction, emotional compatibility, shared interests, and personality traits. By calculating a compatibility score for potential matches, they prioritize individuals with higher scores, increasing the chances of successful matches.

It is important to note that the effectiveness of these algorithms would depend on the quality and accuracy of the data captured through in-app recorded media. Additionally, ethical considerations and user privacy should be carefully addressed to ensure responsible and transparent matchmaking practices. By integrating these algorithms into the matchmaking process, the application can enhance the precision and success rate of connecting individuals based on their compatibility and shared interests. Some embodiments may include using this same data to provide users with targeted advertisements.

### IV. Targeted Advertisements

Embodiments may include the use of targeted advertisements based on the data gathered from a user's dating profile and videos created by the user within the app. The methods described herein may be used for other applications and should not be limited to dating applications. These may include other social media platforms, browser advertisements, etc. In some embodiments, the data may be sold to advertisers to be used for other applications.

In a preferred embodiment, users' data may be collected from videos, and targeted advertisements may be shown to the users based on their facial expression, gender, background, social status, ethnicity, race, gender, or other factors determined from the users' videos.

Targeted advertisements, also known as personalized or tailored advertisements, are a type of marketing strategy that aims to deliver promotional messages to specific individuals or groups based on their demographics, interests, online behavior, or other relevant data. This approach has gained significant popularity in recent years due to advancements in data analytics, artificial intelligence, and digital advertising platforms.

The primary objective of targeted advertisements is to increase the effectiveness and efficiency of advertising campaigns by reaching the most relevant audience. Targeted advertisements leverage the wealth of data available through various sources, such as social media, browsing history, purchase behavior, and location information, to create more personalized and relevant advertising experiences. By analyzing these data points, advertisers can gain insights into consumers' preferences, habits, and needs, allowing them to tailor their messages and offerings accordingly.

One of the key benefits of targeted advertisements is the ability to deliver the right message to the right person at the right time. For example, if a person frequently searches for camping gear online, they may start seeing advertisements for outdoor equipment, camping supplies, or adventure travel experiences. By displaying relevant ads to individuals who have already demonstrated an interest in a particular product or service, advertisers can significantly increase the chances of engagement and conversion.

Targeted advertisements may also enable advertisers to optimize their ad spending by focusing resources on the most promising segments of the market. By narrowing down the target audience, they can minimize wasteful spending on irrelevant impressions and clicks. This not only helps maximize the return on investment but also allows for more effective budget allocation, as advertisers can allocate their resources to channels and platforms that yield the best results.

Some embodiments may include the use of AI or ML models to tailor ads to an individual. If ML (Machine Learning) models were used to scan social media videos to generate data for targeted advertisements, it would represent a significant advancement in the capabilities of targeted advertising. This approach would involve using sophisticated algorithms to analyze the content of videos shared on social media platforms (or dating applications), extracting information about individuals' interests, behaviors, and preferences, and utilizing that data to deliver more precise and relevant advertisements. The process may be executed using data collection, profile building, and advertisement delivery.

Some embodiments may include data collection via users' posted videos. ML models would be employed to scan social media videos and extract relevant information. This could include analyzing the visual content, audio, and even text captions or comments associated with the videos. The ML models would be trained to identify various elements such as objects, locations, activities, expressions, etc. expressed within the videos uploaded by users.

Some embodiments may include building a detailed profile for each user of the application. The extracted data would then be used to build detailed profiles of individuals. ML algorithms would analyze the collected information to determine the users' preferences, interests, hobbies, demographics, and other relevant characteristics. These profiles would provide insights into users' behavior patterns, allowing advertisers to understand their target audience better. Users may also be placed into groups, where people in similar/the same groups would receive the same advertisements.

The advertisements would then be delivered to users based on their tailored characteristics. Advertisers would utilize the collected data and profiles to create and deliver targeted advertisements. ML models would analyze the preferences and interests of individuals to determine which ads are most likely to resonate with them. These ads would then be displayed to the relevant users during their social media browsing experiences (in a preferred embodiment, a dating application), enhancing the chances of engagement and conversion.

By analyzing the visual and contextual information within videos, advertisers can gain a deeper understanding of users' preferences. This enables the delivery of highly relevant advertisements that align with individuals' interests, increasing the chances of engagement and conversion. Instead of being exposed to irrelevant ads, users would see advertisements that are more tailored to their specific interests. This could lead to a more personalized and enjoyable browsing experience, as users encounter products and services that genuinely align with their needs and desires. ML-powered video analysis allows advertisers to allocate their advertising budgets more effectively. By targeting specific audiences who are more likely to be interested in their offerings, advertisers can optimize their ad spend and minimize wasted resources.

The data collected for use in targeted advertisements may include user profiles, visual appearance (including race, gender, ethnicity, hairstyle, clothing choices, etc.) interests and activities, communication styles and other verbal cues, non-verbal cues (body language, eye contact, facial expressions).

Some embodiments include providing users with transparency regarding how their data is used, including targeted advertising or algorithmic matching. Users should have control over their data and the ability to delete or modify their videos and associated information as desired.

This same data may be used with different matchmaking ML models to determine matches between users.

User profiles in dating applications serve as a concise representation of an individual's information, interests, and preferences, allowing users to make informed decisions about potential matches. These profiles typically begin with basic information such as the user's name, age, gender, and location. These details serve as initial filters, helping users narrow down their search based on their preferences for age range and geographical proximity.

One of the most crucial components of a user profile is the collection of profile pictures. Users have the option to upload one or more pictures that showcase their appearance. These images are vital in creating a first impression and attracting potential matches. Users are encouraged to select high-quality, recent pictures that accurately reflect their physical appearance to establish trust and authenticity.

To provide more insights into their personality, users are given the opportunity to write a personal description or bio. In this section, users can express themselves and highlight important aspects of their life. It allows individuals to share their hobbies, passions, values, and what they are seeking in a potential partner. This personal description offers a glimpse into the user's character and serves as a conversation starter or a way to identify common interests with potential matches. This data may be collected and used for targeted advertisements.

Visual appearance is a powerful tool in creating targeted advertisements, allowing advertisers to customize their content and creative elements to resonate with specific audiences. By carefully analyzing visual cues related to appearance, advertisers can develop advertisements that align with individuals' preferences, needs, and aspirations. One aspect where visual appearance can be leveraged is in understanding and targeting specific demographics. By observing visual cues such as age, gender, and ethnicity, advertisers can tailor their campaigns to appeal to particular age groups or cater to gender-specific preferences. Visual appearance can also provide valuable insights into the lifestyle and interests of individuals.

Advertisements can incorporate visual cues related to clothing choices, settings, or activities to create a connection with specific interests or hobbies. By utilizing visual appearance to create targeted advertisements, brands can enhance their messaging and imagery to resonate with the intended audience, increasing the effectiveness and relevance of their campaigns.

Some embodiments may include determining a user's interests and hobbies based on their profile information and the videos created within the app. Interests and activities provide valuable insights that advertisers can utilize to create targeted advertisements. By understanding the hobbies, preferences, and behaviors of individuals, advertisers can tailor their campaigns to align with specific interests, increasing the relevance and effectiveness of their advertisements.

This information enables advertisers to personalize advertisements based on users' specific preferences. By targeting individuals with relevant ads, advertisers can capture their attention and increase the likelihood of engagement and conversion. Analyzing users' activities can help advertisers identify opportunities to showcase their products or services. By leveraging interests and activities, advertisers can create targeted advertisements that resonate with individuals, enhance user experiences, and increase the effectiveness of their marketing campaigns. accents to determine the background of a user.

### V. Additional Embodiments and Areas of Use

A preferred embodiment includes a method that involves allowing users to create and upload video content directly within the application itself. Instead of accepting pre-recorded video files, the application restricts video uploads to recordings made within the app. By implementing this method, the application ensures that the video content shared by users is authentic, unedited, and unfiltered. It prevents users from uploading manipulated or misleading videos that may misrepresent their personal attributes or qualifications. The application provides a built-in recording feature that allows users to capture real-time videos using their device's camera and microphone. This in-app recorded media may include both audio and visual components, enabling users to present themselves genuinely and accurately.

By utilizing in-app recorded media, applications can enforce safety features, maintain the integrity of user profiles, and enhance the overall user experience. It promotes transparency, trust, and fairness by minimizing the risk of deceptive or manipulated content. The specific implementation details of this method can vary depending on the application and its specific features. However, the core concept revolves around allowing users to create and upload video content directly within the application, ensuring the content's authenticity and preventing the use of pre-recorded, edited, or filtered videos.

The following description refers to “in-app recorded media”. This media may pertain to any audio, video, virtual tours, stories/testimonials, event highlights, project showcases, skill demonstrations, etc. made in-app or on a secure website that prevent users from uploading external edited content. In some embodiments, the app/website will force users to record video and/or audio within the app/website to allow only verified content within the app/website. When implementing in-app recorded media on a website, the functionality and user experience may vary slightly compared to a dedicated application. Some embodiments may label content generated within the app differently from content uploaded from an external source. The content in the app is verified by the app, and it would be up to users to gauge whether uploaded content is truthful and honest.

The method of utilizing in-app recorded media can have broader applications beyond dating platforms, such as in the context of interviewing, job applications, talent auditions, roommate searching, professional networking, online courses/training, remote collaborations, legal proceedings, educational assessments/testing, virtual health coaching, therapy sessions. This method may also be useful for video or virtual reality touring of locations such as real estate virtual tours. These applications benefit from unedited and unfiltered content. By leveraging this approach, these applications can benefit from added security and reliability in capturing authentic and unaltered content.

In the case of interviewing applications, the use of in-app recorded media can ensure that interviewees present themselves in an unaltered manner, providing a more accurate representation of their skills, qualifications, and overall presentation. By allowing only in-app recorded videos, the application can enforce a level of trust and authenticity in the interview process.

The use of in-app recorded media adds an extra layer of security by reducing the risk of applicants presenting manipulated or edited content that may misrepresent their abilities or qualifications. This approach promotes fairness and transparency in the selection process, ensuring that employers receive genuine and unfiltered information about candidates.

This method helps establish a level playing field for all applicants. By restricting video uploads to in-app recordings, applicants are given equal opportunities to showcase their skills and personality without relying on advanced editing techniques or filters. It encourages a more merit-based evaluation and prevents unfair advantages that could result from highly edited or enhanced video submissions. The use of in-app recorded media can streamline the application or interviewing process by eliminating the need for external video uploads and the associated file management. This simplification enhances user experience and reduces potential technical issues that may arise from uploading and processing external video files. The adoption of in-app recorded media can enhance security, reliability, and fairness in various applications beyond dating platforms. By ensuring the authenticity and unedited nature of the content, this approach contributes to a more trustworthy and efficient user experience, benefiting both applicants and platforms alike.

In the context of job applications, the use of in-app recorded media offers several advantages that enhance the hiring process. It may provide candidates with an opportunity to go beyond their written resume and cover letter. In-app recorded media allows applicants to create video introductions or demonstrations of their skills, presenting themselves in a more dynamic and engaging manner. This visual representation can give employers a better sense of a candidate's personality, communication style, and overall fit for the role. in-app recorded media for job applications enables employers to assess candidates more effectively. Traditional resumes and cover letters often fall short in providing a comprehensive understanding of an applicant's abilities and potential. By incorporating video content, employers can gauge a candidate's presentation skills, confidence, and enthusiasm, which are valuable qualities in many roles.

This method saves time for both candidates and employers by eliminating the need for initial in-person or phone screenings. Candidates can record their video introductions at their convenience, and employers can review them at a time that suits their schedule. This efficiency allows for a faster and more efficient evaluation of candidates, expediting the decision-making process.

In-app recorded media empowers candidates to showcase their creativity and unique value propositions. Through video demonstrations or presentations, candidates can highlight specific projects, accomplishments, or relevant experiences that set them apart from other applicants. This personalized approach helps candidates leave a memorable impression on employers and increases their chances of being shortlisted for further consideration.

Some embodiments may include using this method for talent auditions/shows. In-app recorded media has the potential to revolutionize talent auditions, offering participants and organizers a range of benefits in terms of accessibility, convenience, and dynamic presentation to both auditionees and organizers/judges. This innovative approach could revolutionize the auditioning experience. By utilizing in-app recorded media, performers would have the opportunity to present their talent in a more captivating and immersive way. Rather than relying solely on traditional audition formats, participants could create and submit videos that showcase their skills, allowing them to express themselves more creatively and dynamically.

One of the key advantages of in-app recorded media is the increased accessibility it would provide. Geographical limitations and travel expenses would no longer be obstacles, as participants could record and submit their auditions from any location. This would expand opportunities for talented individuals who may not have the means to physically attend auditions, thus fostering a more inclusive and diverse talent pool. The convenience and flexibility of in-app recorded media would streamline the audition process for both participants and organizers. Participants could record their auditions at their convenience, eliminating the need for strict scheduling and reducing time constraints. Organizers would have the flexibility to review and evaluate auditions at their own pace, allowing for more thorough assessments and informed decision-making.

In-app recorded media offers a valuable advantage in talent auditions by providing organizers with a convenient tool for archiving and comparison purposes. The ability to easily revisit and review audition videos multiple times significantly enhances the evaluation process, facilitating fair assessments and enabling more accurate comparisons between performances. One of the key benefits of utilizing in-app recorded media for archiving auditions is the preservation of talent showcases. Traditionally, auditions are conducted live, and organizers must rely on their memory or written notes to recall specific details of each performance. However, with in-app recorded media, organizers can access a comprehensive archive of audition videos, ensuring that no nuances or standout moments are missed. This feature allows for a more thorough and detailed evaluation, which ultimately leads to a fairer and more accurate selection process.

The comparison is invaluable in talent auditions. Organizers can easily view and compare auditions side by side, enabling direct comparisons of performances and talent. This functionality eliminates biases that may arise from variations in live audition conditions or the subjective nature of memory. By reviewing auditions in a consistent and controlled manner, organizers can make more objective assessments and decisions based on the merits of each performance. The ability to compare auditions also allows organizers to identify patterns, trends, or standout qualities among the applicants. This analysis can be particularly useful when evaluating candidates for specific roles or identifying potential talent for future opportunities. The ability to review auditions collectively provides a comprehensive overview of the talent pool and assists in identifying exceptional individuals who may have stood out across multiple auditions.

In the realm of roommate searching, the integration of in-app recorded media offers significant advantages that enhance the process of finding compatible roommates.

One of the key benefits of using in-app recorded media in roommate searches is the ability to gain a more comprehensive understanding of potential roommates. Rather than relying solely on written descriptions or static images, individuals can record and share videos that provide a glimpse into their personalities, lifestyles, and daily routines. This multimedia approach enables a deeper connection and allows individuals to assess compatibility based on visual and auditory cues, fostering more informed decisions in the roommate selection process.

In-app recorded media also allows individuals to effectively showcase their living spaces. By recording video tours of their apartments or houses, potential roommates can gain a clearer picture of the layout, amenities, and overall ambiance of the living environment. This feature helps in setting realistic expectations and ensures that individuals searching for roommates can find accommodations that align with their preferences and needs.

Furthermore, in-app recorded media facilitates communication and interaction between potential roommates. Through video introductions, individuals can convey their expectations, house rules, and any specific requirements they may have. This direct and visual communication enables a better understanding of each other's preferences and helps in determining whether there is a potential match in terms of lifestyle, cleanliness, noise tolerance, or other important factors. in-app recorded media simplifies the process of narrowing down potential roommates. Rather than scheduling multiple in-person meetings or lengthy phone conversations, individuals can review recorded videos at their convenience. This saves time and effort, allowing for a more efficient screening process and eliminating the need for unnecessary or inconvenient meetups with incompatible candidates.

Additionally, in-app recorded media can provide a sense of security and confidence during the roommate search. Being able to see and hear potential roommates through recorded videos helps individuals assess their level of comfort and trust. It allows them to evaluate factors such as body language, tone of voice, and overall demeanor, which can contribute to establishing a sense of compatibility and trustworthiness. The integration of in-app recorded media in roommate searching platforms streamlines the process, enhances communication, and provides a more comprehensive view of potential roommates. It enables individuals to assess compatibility based on visual and auditory cues, showcase living spaces, facilitate direct communication, and simplify the screening process. By leveraging this multimedia approach, individuals can increase the likelihood of finding compatible roommates, fostering a harmonious living arrangement and a positive shared living experience.

Some embodiments may include using this method for professional networking. The integration of in-app recorded media for professional networking brings numerous benefits that enhance the networking experience for individuals and businesses. One of the key advantages of in-app recorded media in professional networking is the ability to create dynamic and engaging profiles. Rather than relying solely on static text and images, professionals can utilize recorded videos to introduce themselves, showcase their skills, and highlight their expertise. This multimedia approach enables individuals to make a stronger and more memorable impression on potential connections, enhancing their visibility and increasing the likelihood of meaningful interactions.

In-app recorded media also allows professionals to effectively communicate their personal brand and professional narrative. Through video presentations, individuals can share their career accomplishments, discuss their professional goals, and convey their unique value proposition. This interactive and visual medium provides a deeper insight into their personality, communication style, and overall professional demeanor, fostering a stronger connection and facilitating more targeted networking opportunities.

Furthermore, in-app recorded media simplifies the process of sharing professional achievements and projects. Professionals can record and showcase their work samples, presentations, or portfolios within their profiles, providing a comprehensive overview of their capabilities. This feature eliminates the need for multiple file attachments or external links, streamlining the information-sharing process and enabling connections to quickly assess one's expertise and suitability for collaborations or opportunities.

In the context of professional events or conferences, in-app recorded media can play a transformative role. Participants can record and share video summaries or highlights of their presentations, panel discussions, or workshops, allowing remote attendees or those unable to attend the event in person to still benefit from the knowledge and insights shared. This extends the reach and impact of professional networking events, facilitating knowledge exchange, and fostering connections beyond physical limitations. In-app recorded media enables professionals to engage in virtual networking sessions or interviews. Through video calls or recorded interviews, individuals can have face-to-face interactions with potential employers, clients, or collaborators, regardless of geographical barriers. This functionality not only saves time and resources but also allows for more personal and authentic connections, contributing to building meaningful professional relationships.

Online courses and training have become increasingly popular as a convenient and accessible way for individuals to acquire new knowledge, develop skills, and enhance their professional or personal growth. The integration of in-app recorded media within online courses and training platforms brings numerous benefits to both learners and instructors.

One of the key advantages is the ability for instructors to create and share instructional videos within the app/website. These videos can include lectures, demonstrations, tutorials, or presentations, providing learners with a rich multimedia learning experience. Instructors can utilize the in-app recording feature to capture their teaching materials, ensuring consistency and quality in delivering course content.

The recorded videos allow learners to engage with the course material at their own pace and convenience. They can revisit specific sections, pause or rewind the content, and gain a deeper understanding of complex concepts. The visual and auditory elements of recorded videos enhance comprehension and retention, making the learning process more engaging and effective.

In-app recorded media also enables interactive learning experiences. Learners can participate in virtual discussions, complete assignments, or showcase their skills through recorded presentations or performances. Instructors can provide feedback on these recorded submissions, creating a dynamic and personalized learning environment.

Moreover, the availability of recorded media allows learners to access course materials beyond the scheduled class times. They can review the content from anywhere, at any time, eliminating the limitations of geographical location or time constraints. This flexibility accommodates diverse learning styles and enables individuals to balance their studies with other commitments.

For instructors, in-app recorded media offers opportunities for scalability and reach. They can create a library of recorded content that can be accessed by multiple learners simultaneously, expanding their audience and impact. Additionally, the ability to record and share supplementary materials, such as reading recommendations or additional examples, enhances the overall learning experience and provides learners with valuable resources.

In-app recorded media also facilitates collaboration and peer learning. Learners can record and share their own insights, presentations, or project updates with their peers, fostering a sense of community and allowing for constructive feedback and knowledge exchange.

Some embodiments may include using the method for remote collaborations such as virtual meetings, remote team projects, remote client meetings, remote research collaboration, etc. The integration of in-app recorded media within remote collaboration tools brings added advantages and enhances the collaborative experience.

One of the key benefits is the ability to record and share multimedia content during remote collaboration sessions. In-app recorded media allows participants to capture their ideas, presentations, or demonstrations in video or audio format directly within the collaboration tool. This feature facilitates clear and concise communication by providing visual and auditory elements that enhance understanding and engagement. The recorded media can be shared with team members in real-time or asynchronously, depending on the collaboration platform's capabilities. This allows participants to review and refer back to the shared content at their convenience, ensuring that crucial information is not missed and enabling everyone to stay on the same page. It eliminates the limitations of time zones and availability, making it easier for remote team members to collaborate effectively.

In-app recorded media also promotes clarity and accuracy in remote collaborations. Participants can record their thoughts or instructions, ensuring that details are accurately conveyed and minimizing miscommunications. Visual demonstrations or tutorials can be recorded and shared, enabling team members to follow step-by-step processes or understand complex concepts more effectively. Recorded media provides a valuable reference for future collaboration sessions. Team members can access and revisit the recorded content to refresh their memory, review decisions, or track progress. This promotes continuity and consistency in remote collaborations, particularly when working on long-term projects or when team members join or leave the collaboration at different times.

The integration of in-app recorded media within remote collaboration tools also fosters a sense of connection and engagement among team members. Visual and auditory elements in recorded media add a personal touch to remote interactions, allowing participants to better understand each other's perspectives, non-verbal cues, and tone of voice. This helps to build rapport, trust, and a stronger sense of collaboration despite physical distance. In-app recorded media enables participants to provide feedback or contribute asynchronously. Instead of relying solely on synchronous meetings or written communication, team members can record their input, suggestions, or creative ideas and share them with the group. This allows for more comprehensive and inclusive collaboration, accommodating different working styles and time constraints.

Incorporating in-app recorded media into legal proceedings can bring significant advantages and advancements to the legal system. It offers a range of possibilities to enhance documentation, evidence presentation, and overall efficiency in the legal process.

One key application of in-app recorded media in legal proceedings is the ability to record and store witness testimonies. By using the app/website's recording feature, witnesses can provide their statements in a secure and controlled environment. This ensures the accuracy and authenticity of their testimonies, as the recordings capture their precise words and demeanor. These recordings can then be preserved as evidence and used during court hearings or legal investigations.

In addition to witness testimonies, in-app recorded media can be utilized for recording depositions and legal interviews. Attorneys and legal professionals can record their interviews with clients, experts, or other parties involved in the case. These recordings serve as a comprehensive record of the interaction, ensuring that important details and statements are accurately captured and preserved for future reference.

Another area where in-app recorded media can be beneficial is in presenting evidence. Lawyers can record and organize various forms of evidence, such as audio recordings, video footage, or documents, within the app/website. This centralized repository of evidence simplifies the presentation process, making it easier for legal teams to access and share relevant materials during court proceedings. It enhances the efficiency of evidence management and promotes a streamlined approach to presenting complex information to judges, juries, and opposing counsel.

Moreover, in-app recorded media can facilitate remote participation in legal proceedings. Remote video conferencing, enabled by the app/website, allows individuals to attend hearings, depositions, or meetings from different locations. The ability to record these remote sessions ensures that all parties have access to the proceedings and can review them later if needed. This feature is particularly valuable in situations where physical presence is challenging or costly, such as when dealing with international cases or when witnesses are unable to travel.

Furthermore, in-app recorded media can be instrumental in legal education and training. Law students can utilize the recording feature to practice courtroom presentations, mock trials, or oral arguments. These recorded practice sessions can be reviewed by instructors or peers, providing valuable feedback and facilitating skill development. It offers a convenient and efficient method of honing legal advocacy skills without the need for physical courtroom setups.

Incorporating in-app recorded media into educational assessments and testing brings notable benefits and advancements to the field of education. It offers a versatile tool for conducting assessments, providing feedback, and evaluating student performance.

One key application of in-app recorded media in educational assessments is the ability to capture and evaluate practical or performance-based tasks. Students can record themselves engaging in activities such as presentations, experiments, or artistic performances, showcasing their skills and knowledge in a tangible way. These recordings provide a comprehensive and authentic representation of student performance, allowing educators to assess their abilities more accurately.

Furthermore, in-app recorded media can be utilized for oral examinations and language assessments. Students can record their responses to prompts or questions, allowing for a more flexible and convenient assessment process. This approach eliminates the need for scheduling specific time slots for each student and enables educators to review and evaluate the recordings at their convenience, ensuring fairness and consistency in the assessment process.

In addition to practical assessments, in-app recorded media can facilitate the review of complex problem-solving tasks. Students can record themselves working through mathematical equations, scientific experiments, or coding challenges, demonstrating their problem-solving strategies and thought processes. This provides valuable insights into their understanding and approach, enabling educators to provide targeted feedback and support.

Moreover, in-app recorded media can enhance the assessment of collaborative projects and group assignments. Students working in teams can record their group discussions, presentations, or project demonstrations, showcasing their teamwork, communication, and collaborative skills. These recordings not only assess individual contributions but also allow educators to evaluate the dynamics and effectiveness of the group as a whole.

Additionally, in-app recorded media offers benefits for providing formative feedback and self-assessment opportunities. Students can record themselves practicing a skill, delivering a presentation, or engaging in a performance. They can then review the recording, reflect on their performance, and identify areas for improvement. This reflective process promotes self-directed learning and empowers students to take ownership of their progress.

The use of in-app recorded media in educational assessments also provides an opportunity for asynchronous evaluation and feedback. Educators can review the recordings at their convenience, allowing for more detailed and thoughtful assessments. This flexibility accommodates varying schedules and reduces the pressure of time constraints, enabling educators to provide more comprehensive and personalized feedback to each student.

This may also allow teachers/advisers to determine the validity of remote exam testing. In the context of secure testing and video verification, the integration of in-app recorded media with AI algorithms provides a robust solution to enhance the integrity and accuracy of high-stakes exams such as LSAT, GRE, SAT, ACT, MCAT, and others. The combination of in-app recorded media and AI algorithms offers several benefits, including secure testing environments, video verification, and automated red flag detection.

In-app recorded media ensures a controlled and secure testing environment. By utilizing the app's recording feature, test takers can securely complete their exams within the designated app. This eliminates the risk of unauthorized materials, external assistance, or cheating during the testing process. The recorded media serves as a reliable and verifiable representation of the test taker's performance, allowing for subsequent verification and analysis.

Video verification plays a crucial role in maintaining exam integrity. Test takers are required to record themselves while taking the exam, providing visual and audio evidence of their actions and responses. This video verification process allows exam administrators to verify the identity of the test taker and ensure compliance with testing guidelines. It helps prevent impersonation or unauthorized test-taking, as the recorded video can be cross-checked against identification documents and other personal information.

AI algorithms may be used to scan the recorded videos for red flags or suspicious behaviors that may indicate potential irregularities or violations. The algorithms can analyze various aspects of the video, such as eye movement, body language, and voice patterns, to detect any anomalies or indications of misconduct. These algorithms are trained to identify patterns associated with cheating, unauthorized aids, or other violations of testing protocols. When a potential red flag is detected, the video can be flagged for manual review by human proctors or administrators. The automated red flag detection provided by AI algorithms significantly improves the efficiency and effectiveness of the review process. Instead of manually reviewing every video, which can be time-consuming and resource-intensive, the algorithms identify suspicious cases that require further examination. This targeted approach streamlines the review process and allows human proctors to focus on cases that warrant closer scrutiny, increasing the overall efficiency of the testing system.

Through the use of digital platforms, virtual health coaching brings the expertise of trained professionals directly to the convenience of the individual's home or location of their choice.

One of the key benefits of virtual health coaching is the accessibility it offers. Individuals can connect with health coaches regardless of their geographical location, eliminating the barriers of distance and travel. This is particularly advantageous for those living in remote areas or with limited access to healthcare services. With just a smartphone, tablet, or computer, individuals can engage in virtual sessions and receive ongoing support and guidance from their health coach.

Furthermore, virtual health coaching provides a high level of convenience and flexibility. Sessions can be scheduled at times that suit the individual's schedule, accommodating their personal and professional commitments. This flexibility allows individuals to integrate health coaching into their daily lives without significant disruptions, making it easier to prioritize their well-being. It also eliminates the need for travel to physical coaching locations, saving time and resources.

The use of in-app recorded media in virtual health coaching enhances the coaching experience and outcomes. Individuals can record and share relevant information with their health coach, such as exercise routines, meals, or specific health concerns. This allows the health coach to have a deeper understanding of the individual's lifestyle and challenges, enabling them to provide tailored recommendations and strategies. The recorded media serves as a valuable tool for both the individual and the health coach to track progress, evaluate behaviors, and identify areas for improvement.

Moreover, virtual health coaching empowers individuals to take an active role in their health journey. Through virtual sessions, individuals receive personalized guidance, education, and support from health coaches who specialize in various areas, such as nutrition, fitness, stress management, and behavior change. The coaching process fosters a collaborative partnership between the individual and the health coach, empowering individuals to set goals, make informed decisions, and develop sustainable lifestyle habits.

The use of technology in virtual health coaching also allows for real-time monitoring and feedback. Wearable devices, mobile apps, and connected health tools can track various health metrics, such as physical activity, sleep patterns, or vital signs, providing real-time data to both the individual and the health coach. This data-driven approach enables the health coach to provide timely feedback, adjust the coaching plan, and motivate individuals to stay on track towards their health goals.

Therapy sessions conducted through virtual platforms have become an increasingly popular and effective method of providing mental health support and counseling. Virtual therapy offers numerous benefits, making therapy more accessible, convenient, and comfortable for individuals seeking emotional well-being and support.

One of the key advantages of virtual therapy is increased accessibility. People can engage in therapy sessions from the comfort of their own homes or any location of their choice. This is particularly beneficial for individuals who may have mobility limitations, live in remote areas, or have difficulty accessing traditional therapy settings. Virtual therapy removes barriers of transportation and geographical constraints, ensuring that individuals can receive the support they need regardless of their location.

Integrating in-app recorded media into therapy sessions holds the potential to revolutionize the therapeutic experience, even though it has not been widely implemented yet. By leveraging the capabilities of technology, such as audio and video recording within the therapy app, it opens up new possibilities for self-expression, introspection, and growth in the field of therapy.

In-app recorded media would provide clients with a unique opportunity to capture and document their thoughts, feelings, and experiences in real-time. Clients can record audio or video sessions in the comfort and privacy of their own space, allowing for authentic and unfiltered self-expression. This feature could help individuals articulate their emotions more effectively, particularly when they struggle to convey their experiences solely through verbal communication.

These recorded media can serve as a valuable tool for both clients and therapists. Clients can review their recordings between therapy sessions, reflecting on their emotions, insights, and progress. It would enable them to engage in self-reflection, gain a deeper understanding of their experiences, and track their personal growth throughout the therapeutic journey. The ability to revisit these recordings could reinforce therapeutic insights, encourage self-awareness, and provide a tangible representation of the client's therapeutic evolution.

Therapists, on the other hand, could leverage in-app recorded media to gain additional insights into their clients' experiences. By reviewing the recorded sessions, therapists can observe nonverbal cues, subtle nuances, and patterns of behavior that may have been missed during live sessions. This deeper understanding of the client's emotions and expressions could lead to more accurate assessments, targeted interventions, and personalized treatment plans. It would enhance the therapist's ability to tailor their approach to each client's unique needs and facilitate more effective therapeutic outcomes.

Additionally, in-app recorded media could foster a collaborative therapeutic relationship. Therapists can provide feedback on the client's recordings, offering guidance, validation, and suggestions for personal growth. Clients would receive more comprehensive support, as therapists can provide specific insights and strategies based on the observations from the recorded sessions. This collaborative approach encourages a sense of shared responsibility and active participation, promoting a deeper level of engagement and motivation in the therapeutic process.

The integration of robust security measures within the therapy app would be crucial to ensure the privacy and confidentiality of the recorded media. Implementing encryption protocols and strict data protection measures would safeguard the sensitive information shared by clients, building trust and confidence in the platform. These security measures would be paramount to establish a safe environment where individuals can freely express themselves and engage in therapy with peace of mind.

While the implementation of in-app recorded media in therapy sessions is speculative at this point, it offers exciting possibilities for the future of therapy. The potential benefits include enhanced self-expression, increased self-reflection, deeper therapeutic insights, and a more collaborative and tailored approach to treatment. As technology continues to evolve, it is plausible that in-app recorded media may become a valuable tool in therapy, enriching the therapeutic experience for both clients and therapists alike.

Some embodiments may include the use of a distributed ledger or blockchain to verify the security of the content in the app. The use of a distributed ledger or blockchain technology in the app provides an additional layer of security and verification for the recorded content. By incorporating a distributed ledger or blockchain, the app can ensure that the content generated within the app is authentic and has not been tampered with or altered. This provides an additional layer of verification ensuring that the content was generated in the app, and that it is still the unedited version of that content.

The distributed ledger or blockchain acts as a decentralized and immutable record of all transactions and actions related to the recorded media. Each recording made within the app can be cryptographically hashed and stored on the blockchain, creating a unique digital fingerprint or signature for that specific piece of content.

This digital signature ensures the integrity and security of the recorded media. Any attempt to modify or tamper with the content will result in a change in the digital signature, alerting users to the potential manipulation. This provides a reliable means of verifying the authenticity and originality of the recorded media, enhancing trust and confidence in the app.

Additionally, the distributed nature of the ledger or blockchain adds an extra layer of security. The content is not stored in a centralized location but is distributed across multiple nodes or participants in the network. This decentralized architecture makes it extremely difficult for malicious actors to alter or manipulate the recorded media without detection.

The use of a distributed ledger or blockchain also enhances transparency and accountability. The recorded media transactions, including the creation, modification, or deletion of content, are recorded on the blockchain and can be audited and verified by authorized parties. This promotes transparency in the app's operations and ensures that any changes made to the recorded media are documented and traceable.

Furthermore, the tamper-proof nature of the blockchain technology makes it suitable for legal and regulatory compliance. The verifiability and immutability of the recorded media can serve as legally admissible evidence in court proceedings, arbitration, or dispute resolutions. It provides a reliable and tamper-resistant record that can be relied upon to establish the authenticity and integrity of the content.

By utilizing a distributed ledger or blockchain, the app can establish a robust and trustworthy system for verifying the security and authenticity of the recorded content. This technology ensures that the content is generated within the app, and any modifications or tampering attempts are easily detectable. It enhances the overall security and reliability of the app, providing users with the confidence that their recorded media is protected and trustworthy.

Some embodiments include the use of Background and foreground analysis using AI/ML. Background and foreground analysis using AI/ML refers to the process of distinguishing between the main subject of interest (foreground) and the surrounding context (background) in an image or video using artificial intelligence and machine learning techniques. This analysis plays a crucial role in various computer vision applications, including object recognition, image segmentation, video processing, and scene understanding.

The goal of background and foreground analysis is to automatically identify and extract relevant objects or regions from an input visual data, enabling more efficient processing and analysis of the desired information. Traditional methods for background and foreground separation often relied on manual annotation or rule-based algorithms, which were time-consuming and lacked scalability. However, with the advancements in AI and ML, more accurate and automated techniques have emerged.

AI/ML algorithms for background and foreground analysis typically leverage deep learning architectures, such as convolutional neural networks (CNNs) and recurrent neural networks (RNNs). These models are trained on large datasets containing labeled examples of background and foreground regions. The training process involves optimizing the network's parameters to minimize the difference between predicted and ground truth labels, enabling the model to learn discriminative features that distinguish between the two classes.

Once trained, the AI/ML model can be applied to unseen images or videos for foreground segmentation. The model analyzes the visual data at a pixel or region level and assigns a probability or label indicating whether each element belongs to the foreground or background. This segmentation can be achieved through various techniques, including pixel-wise classification, region proposal methods, or graph-based algorithms.

Foreground extraction using AI/ML has numerous practical applications. In object recognition, foreground analysis helps isolate objects of interest from complex backgrounds, improving the accuracy of object detection and tracking systems. It also aids in image and video editing tasks, such as background removal or replacement, which is useful in the film industry, virtual reality, and augmented reality applications.

Furthermore, foreground analysis is valuable in surveillance systems for detecting and tracking specific objects or individuals in crowded scenes. It enables intelligent video analytics by focusing on relevant objects while disregarding irrelevant or stationary elements. This can be crucial for security monitoring, crowd management, and anomaly detection.

Background and foreground analysis using AI/ML can also be applied in the context of a dating app. In this scenario, the goal is to analyze user profile pictures and automatically differentiate between the main subject (the person) and the background elements in the image.

By employing AI/ML techniques, the dating app can enhance the user experience by automatically cropping or highlighting the person in the profile picture, thereby improving the overall visual presentation. This analysis can help in capturing the attention of potential matches and ensuring that the user's image is displayed prominently.

The process involves training a machine learning model using a dataset of labeled images where the foreground (person) and background are annotated. The model learns to recognize the distinguishing features of the person and differentiate them from the background. Deep learning architectures such as CNNs are commonly used for this purpose due to their ability to learn intricate patterns and features.

Once the model is trained, it can be deployed in the dating app to analyze user profile pictures in real-time. The AI/ML model will evaluate the image and accurately determine the boundaries of the person, enabling the app to highlight or crop the photo accordingly. This automated foreground extraction simplifies the user's task, as they do not have to manually adjust their profile picture to ensure the focus is on them.

Moreover, background and foreground analysis can be combined with other AI/ML techniques to offer additional features in the dating app. For instance, the analysis can be used to verify the authenticity of profile pictures by checking if the foreground aligns with expected human features. This can help in reducing the likelihood of fake profiles or misleading images.

In-app recorded media offers a valuable advantage in coaching by providing coaches with a convenient tool for archiving and analysis purposes. The ability to easily revisit and review coaching sessions multiple times significantly enhances the evaluation process, facilitating effective assessments and enabling more accurate comparisons between performances. One of the key benefits of utilizing in-app recorded media for archiving coaching sessions is the preservation of training progress. Traditionally, coaching sessions rely on real-time interactions, and coaches must rely on their memory or written notes to recall specific details of each session. However, with in-app recorded media, coaches can access a comprehensive archive of coaching videos, ensuring that no nuances or critical moments are missed. This feature allows for a more thorough and detailed evaluation, which ultimately leads to more effective coaching and skill development.

The comparison is invaluable in coaching sessions. Coaches can easily view and compare sessions side by side, enabling direct comparisons of performances and progress. This functionality eliminates biases that may arise from variations in live coaching conditions or the subjective nature of memory. By reviewing coaching sessions in a consistent and controlled manner, coaches can make more objective assessments and decisions based on the merits of each session. The ability to compare sessions also allows coaches to identify patterns, trends, or standout qualities among the individuals being coached. This analysis can be particularly useful when evaluating skill development or identifying areas of improvement. The ability to review sessions collectively provides a comprehensive overview of the coaching process and assists in identifying effective coaching techniques or strategies.

In the realm of personal development and self-improvement coaching, the integration of in-app recorded media offers significant advantages that enhance the coaching process.

One of the key benefits of using in-app recorded media in coaching is the ability to gain a more comprehensive understanding of clients. Rather than relying solely on verbal descriptions or static information, clients can record and share videos that provide insights into their behavior, communication style, and challenges they face. This multimedia approach enables a deeper connection and allows coaches to assess client needs and tailor coaching sessions more effectively.

In-app recorded media also allows clients to effectively showcase their progress. By recording videos of their practice sessions or applying the concepts discussed during coaching, clients can provide tangible evidence of their development. This feature helps in setting realistic expectations, tracking progress, and celebrating achievements.

Furthermore, in-app recorded media facilitates communication and interaction between coaches and clients. Through video messages or recorded feedback, coaches can provide personalized guidance and support. This direct and visual communication enables better understanding and helps in addressing specific client needs effectively. In-app recorded media simplifies the coaching process by allowing clients to review recorded videos at their convenience. This saves time and effort, fostering a more efficient coaching experience and eliminating the need for unnecessary or inconvenient in-person meetings.

Additionally, in-app recorded media can provide a sense of security and confidence during the coaching journey. Being able to see and hear coaches through recorded videos helps clients assess their level of comfort and trust. It allows them to evaluate factors such as coaching style, expertise, and overall demeanor, which can contribute to establishing a productive coaching relationship. The integration of in-app recorded media in coaching platforms streamlines the process, enhances communication, and provides a more comprehensive view of clients' progress. It enables coaches to assess client needs based on visual and auditory cues, track development, facilitate direct communication, and simplify the coaching experience. By leveraging this multimedia approach, coaches and clients can achieve more impactful coaching outcomes, fostering personal growth and facilitating positive transformations.

In-app recorded media offers a valuable advantage in coaching children's sports by providing coaches with a convenient tool for reviewing and analyzing training sessions. The ability to easily revisit and assess recorded videos significantly enhances the coaching process, facilitating effective evaluations and enabling more accurate feedback. One of the key benefits of utilizing in-app recorded media is the ability to capture and preserve children's sports performances. Traditionally, coaches rely on their observations and memory to recall specific details of each training session. However, with in-app recorded media, coaches can access a comprehensive archive of videos, ensuring that no crucial moments or areas of improvement are missed. This feature allows for a more thorough and detailed evaluation, which ultimately leads to more effective coaching and skill development for children.

The comparison is invaluable in coaching children's sports. Coaches can easily view and compare recorded sessions side by side, enabling direct comparisons of performances and progress over time. This functionality eliminates biases that may arise from variations in live coaching conditions or the subjective nature of memory. By reviewing sessions in a consistent and controlled manner, coaches can make more objective assessments and decisions based on the merits of each child's performance. The ability to compare sessions also allows coaches to identify patterns, track improvements, and pinpoint areas for further development. This analysis can be particularly useful when tailoring training plans and identifying individual strengths and weaknesses. The ability to review sessions collectively provides a comprehensive overview of the child's progress and assists in creating customized coaching strategies for their specific needs.

In the realm of coaching children's sports, the integration of in-app recorded media offers significant advantages that enhance the coaching experience.

One of the key benefits of using in-app recorded media in children's sports coaching is the ability to provide visual feedback. Rather than relying solely on verbal instructions, coaches can use recorded videos to demonstrate techniques, correct form, and highlight areas for improvement. This multimedia approach enables better understanding and retention of coaching instructions by children, enhancing their learning experience.

In-app recorded media also allows children to review and reflect on their own performances. By watching their recorded sessions, children can self-assess and gain a better understanding of their strengths and areas that require further development. This self-reflection promotes self-awareness, autonomy, and active participation in the learning process.

Furthermore, in-app recorded media facilitates parent-coach communication. Coaches can share recorded videos with parents to keep them informed about their child's progress and provide insights into training techniques and goals. This collaboration between parents and coaches helps create a supportive environment for children's sports development and enables parents to actively engage in their child's training journey.

Additionally, in-app recorded media can serve as a motivational tool. Children can watch their own progress over time, witnessing their improvement and celebrating their achievements. This visual representation of progress boosts confidence fosters a sense of accomplishment and motivates children to continue working on their skills.

The integration of in-app recorded media in children's sports coaching platforms streamlines the coaching process, enhances communication, and provides a more comprehensive view of children's progress. It enables coaches to provide visual feedback, encourages self-reflection, facilitates parent-coach collaboration, and serves as a motivational tool for children. By leveraging this multimedia approach, coaches can create more effective training programs, foster skill development, and support the overall growth and enjoyment of children participating in sports.

In-app recorded media offers a valuable advantage in the context of an app for meeting financial planners/advisers by providing users with a convenient tool for evaluating and comparing professionals. The ability to easily access and review recorded videos significantly enhances the selection process, facilitating informed decisions and enabling more accurate comparisons between financial planners/advisers. One of the key benefits of utilizing in-app recorded media is the preservation of professional showcases. Traditionally, individuals seeking financial advice rely on resumes, written descriptions, or in-person meetings to evaluate planners/advisers. However, with in-app recorded media, users can access a comprehensive archive of videos showcasing the expertise, communication style, and financial insights of the professionals. This feature allows for a more thorough and detailed evaluation, which ultimately leads to more informed choices and better alignment with individual financial goals.

The comparison is invaluable in an app for meeting financial planners/advisers. Users can easily view and compare recorded videos side by side, enabling direct comparisons of professionals' expertise, communication skills, and approach to financial planning. This functionality eliminates biases that may arise from variations in live meetings or the subjective nature of memory. By reviewing videos in a consistent and controlled manner, users can make more objective assessments and decisions based on the merits of each planner/adviser. The ability to compare videos also allows users to identify patterns, identify compatible styles, and pinpoint professionals who align with their specific financial needs or investment preferences. This analysis can be particularly useful when seeking specialized advice or targeting specific financial goals. The ability to review videos collectively provides a comprehensive overview of the available professionals and assists in finding the right financial planner/adviser.

In the realm of financial planning and advisory services, the integration of in-app recorded media offers significant advantages that enhance the user experience.

One of the key benefits of using in-app recorded media is the ability to gain a more comprehensive understanding of financial planners/advisers. Rather than relying solely on written profiles or recommendations, users can watch recorded videos that showcase the expertise and communication style of the professionals. This multimedia approach provides a deeper insight into the professionals' abilities and helps users assess their compatibility.

In-app recorded media also allows users to make direct comparisons between financial planners/advisers. By reviewing recorded videos side by side, users can assess the professionals' communication skills, investment strategies, and overall approach to financial planning. This comparative analysis enables users to make informed decisions and select the professional who best aligns with their financial goals and preferences.

Furthermore, in-app recorded media facilitates a more efficient and convenient selection process. Users can access a comprehensive archive of videos from various financial planners/advisers, eliminating the need for multiple in-person meetings or lengthy phone conversations. This saves time and effort, allowing users to narrow down their choices and focus on the professionals who stand out to them.

Additionally, in-app recorded media can provide a sense of confidence and trust. By watching professionals' recorded videos, users can assess their expertise, demeanor, and professionalism. This visual and auditory evaluation helps users build trust and establish a connection with the selected financial planner/adviser.

Gamification can be an effective approach to enhance user engagement and make a dating app more enjoyable. To incorporate gamification into your dating app, it's important to follow a structured approach.

First, define clear goals and objectives for your gamification strategy. Determine what specific outcomes you want to achieve, such as increasing user activity, promoting meaningful interactions, or encouraging profile completion. These goals will serve as the foundation for your gamification efforts.

Next, identify game elements that can be integrated into your app. Consider elements like points, levels, badges, virtual currency, leaderboards, challenges, or achievements. Choose elements that align with your app's goals and will enhance the user experience. For example, you can award points or badges for completing profile sections, uploading photos, or engaging in conversations.

Users on the platform can earn points by completing various quests and challenges, with a primary focus on facilitating real-world interactions. These quests involve meeting in person with other users, thereby promoting meaningful connections and discouraging the common trend of matches never materializing into real-life meetings.

To encourage users to share more about themselves, points can also be earned by uploading photos using an in-app recorded media feature. This feature not only enhances user engagement but also contributes to increased safety by verifying the authenticity of user profiles through visual content.

Additionally, points can be obtained by uploading photos of users with their matches to their respective user accounts, further incentivizing users to share their dating experiences. These collected points can then be used to unlock various in-app rewards, such as banners and profile icon borders, providing users with a sense of achievement and personalization.

Some embodiments may include offering gift cards as a reward, which can serve as an additional incentive for users to actively participate in the dating application, ultimately enhancing their overall experience and encouraging in-person matching.

These points may also be used to purchase in-app rewards, such as a free month of VIP access or higher tier access,

One effective gamification technique is to incentivize profile completion. Make the process of completing a profile fun and engaging by turning it into a game. For instance, you can provide users with a progress bar that tracks their profile completion and rewards them at different milestones. Offering virtual rewards or unlocking special features when users reach certain profile completion levels can motivate them to provide more information and create more comprehensive profiles.

The following are milestones that may be possible for a user account to receive points or rewards; completing essential information such as name, age, gender, background, and location, uploading their profile photo, uploading multiple photos to their profile, writing a bio and/or list their interests, answering personality questions, inputting work and education, adding hobbies, completing all other sections, daily bonus/rewards, connecting in-person with other users, referring/recommending others to the app.

The following are rewards that a user may receive with points, in-app or completion of certain milestones: virtual badge or sticker for their profile, access to a VIP or high-tier subscription for a limited amount of time, access to premium photo filters or frames, a profile customization option (such as choosing a unique background theme), a virtual trophy or badge for completing certain actions, access to a compatibility analysis feature, access to exclusive community forums or chat groups, access to a “Career Match” feature that connects people in similar fields, access to a virtual event or meetup organizer feature, points or in-app currency such as gems or coins.

These milestones and rewards can not only make profile completion more engaging but also encourage users to provide more information, engage with the app's features, and refer others, ultimately enhancing the overall user experience and retention rates.

Consider implementing challenges or quests to encourage users to interact with the app and engage with other users. These challenges can involve tasks like initiating a certain number of conversations, going on a date, or receiving positive feedback from other users. By completing these challenges, users can earn points, unlock achievements, or gain recognition on leaderboards.

To foster a sense of competition and community, introduce leaderboards that showcase top users based on various metrics like activity level, successful matches, or positive feedback received. This can motivate users to strive for the top position and create a sense of friendly competition.

Finally, ensure that the gamification elements are seamlessly integrated into the user interface and experience of your dating app. Make them visually appealing, easy to understand, and accessible to all users. Regularly assess the impact of your gamification efforts through user feedback and data analysis to fine-tune and improve the gamification features over time.

By incorporating gamification elements into your dating app, you can create a more engaging and interactive experience for users, incentivize desired behaviors, and ultimately increase user satisfaction and retention.

Implementing AI to provide tips on how users can enhance their appeal in a dating app can be a valuable feature to assist users in presenting themselves effectively. AI algorithms can analyze user profiles, behavior, and interactions to offer personalized recommendations and guidance.

One area where AI can be utilized is profile enhancement. By examining user profiles, AI can provide suggestions on optimizing bio descriptions, selecting attractive profile pictures, or highlighting key interests. This guidance can help users make a positive first impression and attract potential matches.

Another way AI can assist users is by offering communication guidance. AI algorithms can analyze conversation patterns, language use, and response rates to provide advice on improving communication skills. It can suggest topics to discuss, provide tips for engaging conversations, or highlight potential areas for improvement based on successful interactions.

Additionally, AI can offer personalized recommendations for potential matches. By considering user preferences, behavior, and compatibility scores, AI algorithms can suggest individuals who align with a user's interests and increase the likelihood of meaningful connections.

Furthermore, AI can provide real-time feedback on users' interactions. It can offer insights into response times, the positivity of messages, or the level of engagement in conversations. This feedback can help users adjust their approach and improve their overall communication style.

While implementing AI tips for enhancing appeal, it's crucial to strike a balance between providing helpful suggestions and respecting user autonomy. Users should always have the option to accept or reject AI-generated advice and make their own decisions about how they present themselves. By leveraging AI in these ways, dating app users can receive valuable guidance to improve their profiles, communication skills, and overall dating experience.

In addition to providing tips and recommendations, incorporating quizzes about matches can be an engaging feature in a dating app. Here's how it can be implemented:

One way to keep users engaged and encourage interaction is by incorporating quizzes related to their matches. After a certain period, such as 10 days, if a match is still active and not deleted, users can be presented with a quiz about their match to foster deeper connections and meaningful conversations.

The quizzes can be designed to explore common interests, values, or preferences between the users. For example, questions can cover topics like favorite movies, hobbies, travel destinations, or future aspirations. Users can take turns answering questions, and their responses can be shared between them as conversation starters.

The quiz feature can provide a fun and interactive way for users to get to know each other better and discover shared interests. It can also serve as an icebreaker for those who may find it challenging to initiate conversations.

To ensure privacy and respect user preferences, it's important to obtain consent before sharing quiz results with matches. Users should have the option to participate or skip the quizzes based on their comfort level. Additionally, users can be given control over the visibility of their quiz responses to their matches.

Implementing quizzes about matches can add a playful element to the dating app experience, foster deeper connections, and provide users with more meaningful topics to discuss, ultimately enhancing the overall user engagement and satisfaction.

To further enhance user engagement and incentivize participation, offering rewards for completing quizzes about matches can be a valuable addition to the dating app experience. By incorporating a reward system, users can be motivated to actively participate in quizzes and engage with their matches.

One approach is to introduce a virtual currency or points system, where users earn rewards upon completing quizzes. Accumulated virtual currency or points can then be used to unlock additional features, access premium content, or enhance the overall user experience within the app. This provides users with a tangible incentive for their participation and encourages them to continue engaging in quizzes.

Another option is to implement a system of badges or achievements that users can earn as they successfully complete quizzes. These badges can be displayed on their profiles, showcasing their level of engagement and expertise in getting to know their matches. This gamified element adds an element of competition and recognition, motivating users to complete quizzes and earn more badges.

The dating application may also include a verification badge associated with the a user upon successful verification of their uploaded unedited and unfiltered videos, indicating their authenticity to other users.

Additionally, users can be rewarded with levels or ranks based on their quiz participation. As they progress through the levels, they can unlock special perks, features, or exclusive content. This leveling system provides a sense of progression and achievement, encouraging users to actively participate in quizzes to advance their status within the app.

By integrating a reward system for completing quizzes about matches, dating app users are not only incentivized to actively engage in the quizzes but also have a sense of accomplishment and enjoyment in the process. This ultimately contributes to a more interactive and rewarding dating app experience.

The dating app offers users a comprehensive personality survey designed to uncover their preferences, interests, values, and communication styles. This survey serves as a valuable tool for users to gain insight into their own personalities, laying the groundwork for more compatible matches. Rather than assigning individuals to predefined labels such as “nerd” or “jock,” our focus is on celebrating individuality and authenticity. We emphasize the importance of embracing one's unique qualities and staying true to oneself. Some embodiments may focus on putting different people in different categories and matching them based on those categories.

Rather than making recommendations based on stereotypes, our AI provides guidance on enhancing the overall dating experience. This may include improving communication skills, broadening one's range of interests, or boosting self-confidence. Our ultimate objective is to empower users to grow personally and establish connections rooted in genuine compatibility and shared values, rather than conforming to societal expectations.

What is claimed is:

1. A system for increasing user activity on a dating application comprising:
a dating application;
a user;
an in-app currency;
a user account with at least one feature allowing the user to personalize their account and upload videos to their account;
an in-app recorded media feature with an in-app recorded media module for uploading and recording real-time video content directly through the dating application; and
a video analysis module that utilizes at least one AI/ML algorithm to detect human faces;
wherein the user uploads a video to their account using the in-app recorded media feature, a face is detected in the video by the video analysis module, and the user is rewarded in-app currency for uploading the video.

2. The system of claim 1, wherein the in app-currency is one of points, coins, and gems.

3. The system of claim 2, wherein the in-app currency is exchanged for a reward.

4. The system of claim 3, wherein the reward is one of a virtual badge or virtual sticker for their profile, access to a VIP or high-tier subscription for a limited amount of time, access to premium photo filters or frames, a profile customization option, a virtual trophy, access to an exclusive community forum, and access to a virtual event or meetup organizer feature.

5. The system of claim 1, wherein the in-app recorded media feature allows the user to edit or filter the uploaded video.

6. The system of claim 1, wherein the in-app recorded media feature prohibits the user from editing or filtering the uploaded video.

7. The system of claim 1, wherein users may receive in-app currency for referring other users to the app.

8. The system of claim 1, wherein the in-app recorded media module includes a live video streaming option, allowing users to engage in real-time video interactions with potential matches.

9. The system of claim 1, further comprising a user feedback mechanism allowing other users to report suspicious or inappropriate videos.

10. The system of claim 1, wherein the video analysis module incorporates metadata analysis to verify a time and location of the video recording.

11. The system of claim 13, wherein the video analysis module also incorporates voice analysis, and object detection.

12. The system of claim 1, wherein the video analysis module is used to determine at least one of the user's age, race, ethnicity, gender, and background.

13. The system of claim 1, wherein the video analysis module further comprises:
employing machine learning algorithms to continuously improve the accuracy and reliability of attribute determination from the uploaded videos;
utilizing data from user interactions and feedback to refine the video analysis process and enhance the matching algorithms; and
customizing the matching algorithms to prioritize specific attributes based on user preferences and feedback.

14. A system for increasing user activity on a dating application comprising:
a dating application;
a user;
an in-app currency;
a user account with at least one feature allowing the user to personalize their account and upload videos to their account; and
an in-app recorded media feature with an in-app recorded media module for uploading and recording real-time video content directly through the dating application;
wherein the user uploads user information, the user information pertaining to the user's name, age, and gender, to the user account, and the user is rewarded in-app currency for uploading the user information.

15. The method of claim 14, wherein the in app-currency is one of points, coins, and gems.

16. The method of claim 15, wherein the in-app currency is exchanged for a reward.

17. The system of claim 16, wherein the reward is one of a virtual badge or virtual sticker for their profile, access to a VIP or high-tier subscription for a limited amount of time, access to premium photo filters or frames, a profile customization option, a virtual trophy, access to an exclusive community forum, and access to a virtual event or meetup organizer feature.

18. The method of claim 14, wherein the user information uploaded to the user account also includes the user's ethnicity and job status.

19. The method of claim 14, wherein the user is rewarded for meeting users of the app in-person.

20. A system for increasing user activity on a dating application comprising:
a dating application;
a user;
an in-app currency;
a user account with at least one feature allowing the user to personalize their account and upload videos to their account;
an in-app recorded media feature with an in-app recorded media module for uploading and recording real-time video content directly through the dating application; and
a video analysis module that utilizes at least one AI/ML algorithm to detect human faces;
wherein the user uploads a video to their account using the in-app recorded media feature, a face is detected in the video by the video analysis module, and the user is rewarded in-app currency for uploading the video.
wherein the user uploads user information, the user information pertaining to the user's name, age, and gender, to the user account, and the user is rewarded in-app currency for uploading the user information.
